(19) United States
(12) Patent Application Publication
(10) Pub. No.: US 2004/0148262 A1
(43) Pub. Date: Jul. 29, 2004

(54) License management apparatus and method, service offer apparatus and method, license management program, service offer program and recording medium storing such programs

(76) Inventor: Yohei Yamamoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/706,092

(22) Filed: Nov. 13, 2003

(30) Foreign Application Priority Data
Nov. 14, 2002 (JP) 2002-331210
Nov. 14, 2002 (JP) 2002-331211
Nov. 5, 2003 (JP) 2003-375267
Nov. 5, 2003 (JP) 2003-375268

(51) Int. Cl. G06F 17/60

(52) U.S. Cl. 705/59

(57) ABSTRACT

A license management server manages service use licenses so that a necessary number of the service use licenses are used only when they are actually needed. A license acquisition request receiving section receives an acquisition request for the license from a service offer service. A license sending section sends the service use license to the service offer service in response to the acquisition request for the license.

### BACKGROUND OF THE INVENTION

1. Field of the Invention

The present invention generally relates to license management apparatuses and methods and service offer apparatuses and methods and, more particularly, to a license management server and a service offer server which manage licenses for providing services to a client.

2. Description of the Related Art

A description will now be given, with reference to FIG. 1, of a conventional system in which a service use service uses services through a service offer service. FIG. 1 is an illustration for explaining a conventional example.

As shown in FIG. 1, a client 200 in which a service use service 210 operates is connected to a server 100 in which a service offer service 110 operates through a network 300.

In the example of FIG. 1, the service offer service 110 comprises a service 120, a session management section 130 and an authentication section 140.

In step S10, the service use service 210 of the client 200 sends a use permission request of the service offer service 110 to the session management section 130 of the service offer service 110.

Following step S10, the routine proceeds to step S11 where the session management section 130 sends an issue request of the service use license, which is needed when the service use service 210 uses the service 120, to the authentication section 140.

Following step S11, the routine proceeds to step S12 where the authentication section 140 sends the service use license to the session management section 130.

Following step S12, the routine proceeds to step S13 where the session management section 130 sends a session ID to the service use service, the session ID corresponding to a use permission of a service use service 210 corresponding to the service use license acquired in step S12.

Using the acquired session ID, the service use service 210 can use the service offer service 110 while the session ID is effective.

For example, when the service use service 210 attempts to use the service 120, the service use service 210 sends a use permission request of the service 120 containing the above-mentioned session ID to the session management section 130.

On the other hand, session management section 130 manages the above-mentioned session ID and the service use license by relating to each other. When receiving the use permission request of the service 120 from the service use service, the session management section 130 acquires a service use license corresponding to the session ID contained in the use permission request and initializes the service 120. Then, the session management section 130 sends a use permission of the service 120 to the service use service 210.

FIG. 2 shows an example in which there are a plurality of service offer services 110-1, 110-2 and 110-3 each corresponding to the service offer service 110 shown in FIG. 1, and the authentication section 140, which is contained in the service offer service 110 shown in FIG. 1, is shared by the service offer services 110-1, 110-2 and 110-3. FIG. 2 is an illustration of another conventional example.

As shown in FIG. 2, if the service use service 210 sends use permission requests of the services 120-1, 120-2 and 120-3 simultaneously to three service offer services 110-1, 110-2 and 110-3, and acquires a use permission from each of the service offer services 110-1, 110-2 and 110-3, the three service use licenses are used simultaneously.

In the case shown in FIG. 2, the authentication section 140 counts that one client 200 is using the three service use licenses.

In the conventional method and server, the service offer license is used for each of the service offer services 110-1, 110-2 and 110-3. Thus, there is a problem in that the number of service use licenses is incremented each time the service use service 210 sends the use permission of the service 120 to one of the service offer services 110-1, 110-2 and 110-3 and receives the corresponding use permission.

For example, as shown in FIG. 2, when one 10V client 200u simultaneously sends the use permission request of the services 120-1, 120-2 and 120-3 to the three service offer services 110-1, 110-2 and 110-3, respectively, and when the client 200 receives the corresponding use permission, three service use licenses are used.

Moreover, in the above-mentioned method and server, when a use of the services 120-1, 120-2 and 120-3 is permitted to the service use service 210, there is a problem in that the service use license is continuously used while the use is permitted.

### SUMMARY OF THE INVENTION

It is a general object of the present invention to provide a license management server and a service offer server in which the above-mentioned problems are eliminated.

A more specific object of the present invention is to provide a license management server and a service offer server which manage service use licenses so that a necessary number of the service use licenses are used only when they are actually needed.

In order to achieve the above-mentioned objects, there is provided according to one aspect of the present invention a license management apparatus for managing a license associated with a service that is provided from service offer means to service use means, the license management apparatus comprising: license management means for managing the license; license acquisition request receiving means for receiving an acquisition request for the license from said service offer means; and license sending means for sending the license to said service offer means in response to the acquisition request for the license.

The license management apparatus according to the present invention may further comprise license counting means for counting a value associated with the license. In the license management apparatus, the license counting means may counts the value when the license is acquired from authentication means that issues the license. Alternatively, the license counting means may count the value when the license is sent to said service offer means in response to the acquisition request for the license.

In the license management apparatus according to the present invention, the acquisition request for the license may include a license identifier that identifies the license. The license management means may manage the license and the license identifier that identifies the license by relating to each other.

The license management apparatus according to the present invention may further comprise license identifier acquisition request receiving means for receiving an acquisition request for the license identifier that identifies the license. The license management apparatus may further comprise license identifier sending means for sending the license identifier to a requesting means in response to the acquisition request for the license identifier that identifies the license.

Additionally, there is provided according to another aspect of the present invention a service offer apparatus comprising service offer means for providing a service-to service use means, wherein the service offer means comprises: license acquisition request sending means for sending an acquisition request for the license associated with the service to license managing means for managing the license; and license receiving means for receiving the license from said license management means.

In the service offer apparatus according to the present invention, the acquisition request for the license may contain a license identifier that identifies the license. The service offer apparatus according to the present invention may further comprise license sending means for sending the license acquired from said license management means to said license management means.

Additionally, there is provided according to another aspect of the present invention a license management method for managing a license associated with a service that is provided from service offer means to service use means, the license management method comprising: a license management step of managing the license; a license acquisition request receiving step of receiving an acquisition request for the license from said service offer means; and a license sending step of sending the license to said service offer means in response to the acquisition request for the license.

The license management method according to the present invention may further comprise a license counting step of counting a value associated with the license. In the license management method according to the present invention, in the license counting step, the value associated with the license is counted when the license is acquired from authentication means that issues the license.

Additionally, in the license management method according to the present invention, in the license counting step, the value associated with the license is 1O counted when the license is sent to the service offer means in response to the acquisition request for the license. The acquisition request for the license may include a license identifier that identifies the license. In the license management step, the license and the license identifier that identifies the license may be managed by being related to each other.

The license management method according to the present invention may further comprise a license identifier acquisition request receiving step of receiving an acquisition request for the license identifier that identifies the license. The license management method according to the present invention may further comprise a license identifier sending step of sending the license identifier to a requesting means in response to the acquisition request for the license identifier that identifies the license.

Additionally, there is provided according to another aspect of the present invention a service offer method for providing a service from service offer means to service use means, comprising: a license acquisition request sending step of sending an acquisition request for the license associated with the service to license managing means that manages the license; and a license receiving step of receiving the license from said license management means.

In the service offer method according to the present invention, the acquisition request for the license may contain a license identifier that identifies the license. The service offer method according to the present invention may further comprise a license sending step of sending the license acquired from said license management means to said license management means.

Additionally, there is provided according to another aspect of the present invention a license management program for causing a computer to perform the above-mentioned license management method. A recording medium storing the license management program is also provided according to the present invention.

Further, there is provided according to another aspect of the present invention a service offer program for causing a computer to perform the above-mentioned service offer method. A recording medium storing the service offer program is also provided according to the present invention.

According to the present invention, the service use license is managed so that an appropriate number of service use license can be provided at an appropriate time. Thus, the number of service use licenses that are actually issued can be minimized, which prevents an unnecessary consumption of the service use licenses.

Other objects, features and advantages of the present invention will become more apparent from the following descriptions when read in conjunction with the accompanying drawings.

### BRIEF DESCRIPTION OF THE DRAWINGS

FIG. 1 is an illustration for explaining a conventional example of a system in which a service use service uses services through a service offer service;

FIG. 2 is an illustration for explaining another conventional example of a system in which a service use service uses services through a service offer service;

FIG. 3 is a conceptual illustration for explaining a license management method and a service offer method according to the present invention;

FIG. 4 is an illustration for explaining an example in which a service management service and service offer services are operated in the same server;

FIG. 5 is a block diagram of hardware of the example of a license management server shown in FIG. 4;

FIG. 6 is an illustration for explaining an example in which service management service and service offer services operate in different servers;

FIG. 7 is a hardware structural diagram of the license management server explained with reference to FIG. 6;

FIG. 8 is a hardware structural diagram of the service offer server explained with reference to FIG. 6;

FIG. 9 is a functional block diagram of the service management service;

FIG. 10 is a functional block diagram of an example of the service offer services;

FIG. 13 is an illustration for explaining an example of a first session start response;

FIG. 14 is an illustration for explaining an example of a structure of a first session object;

FIG. 15 is an illustration for explaining an example of a structure of a first session management table;

FIG. 16 is a flowchart of an example of a start process of a session between the service use service and the service management service;

FIG. 17 is an illustration for explaining a procedure of acquiring the license ID;

FIG. 18 is an illustration for explaining an example of a license ID acquisition request;

FIG. 19 is an illustration for explaining an example of a License ID acquisition response;

FIG. 20 is an illustration for explaining an example of a structure of a license ID management table;

FIG. 21 is a flowchart of an example of a license ID acquisition process;

FIG. 22 is an illustration for explaining an example of a start procedure of a session between the service use service and the service offer service;

FIG. 23 is an illustration for explaining an example of a second session start request;

FIG. 24 is an illustration for explaining an example of a second session start response;

FIG. 25 is an illustration for explaining an example of the structure of a second session object;

FIG. 26 is an illustration for explaining an example of a structure of a second session management table;

FIG. 27 is a flowchart of an example of a start process of a session between the service use service and the service offer service;

FIG. 28 is a flowchart of an example of a license ID authentication process in the service management service;

FIG. 29 is an illustration for explaining an example of an accumulated document acquisition procedure;

FIG. 30 is an illustration for explaining an example of an accumulated document acquisition request;

FIG. 31 is an illustration for explaining an example of an accumulated document acquisition response;

FIG. 32 is a flowchart of an example of the accumulated document acquisition process in the service offer service;

FIG. 33 is a flowchart of another example of the license ID authentication process in the service management service;

FIG. 34 is an illustration for explaining another example of a start procedure of a session between the service use service and the service management service;

FIG. 35 is a flowchart of another example of a start process of a session between the service use service and the service management service;

FIG. 36 is an illustration for explaining another example of a start procedure of a session between the service use service and service offer service;

FIG. 37 is a flowchart of another example of the license ID authentication process;

FIG. 38 is an illustration for explaining another example of the accumulated document acquisition procedure;

FIG. 39 is a flowchart of another example of the license ID authentication process in the service management service;

FIG. 40 is a block diagram for explaining another example in which the service management service and the service offer services operate in separate servers;

FIG. 41 is a block diagram for explaining another example in which the service management service and the service offer services operate in separate servers;

FIG. 42 is a block diagram for explaining an example in which the service operates outside the service offer service;

FIG. 43 is a block diagram for explaining an example in which the services and the service authentication section are in the same server;

FIG. 44 is a functional block diagram of an example of a service management service in a seventh embodiment;

FIG. 45 is a functional block diagram of an example of the service offer service in the seventh embodiment;

FIG. 46 is an illustration for explaining an example of a accumulated document acquisition procedure in the seventh embodiment;

FIG. 47 is an illustration for explaining an example of an accumulated document acquisition request in the seventh embodiment;

FIG. 48 is a flowchart of an example of the accumulated document acquisition process in the seventh embodiment;

FIG. 49 is a flowchart of an example of the first session ID authentication process in the seventh embodiment;

FIG. 50 is an illustration for explaining an example of a system structure of an eighth embodiment according to the present invention;

FIG. 51 is an illustration for explaining an example in which the same license ID is converted into different character strings;

FIG. 52 is a flowchart of an example of the license ID acquisition process in the eighth embodiment; and

FIG. 53 is a flowchart of an example of the license ID authentication process in the eighth embodiment.

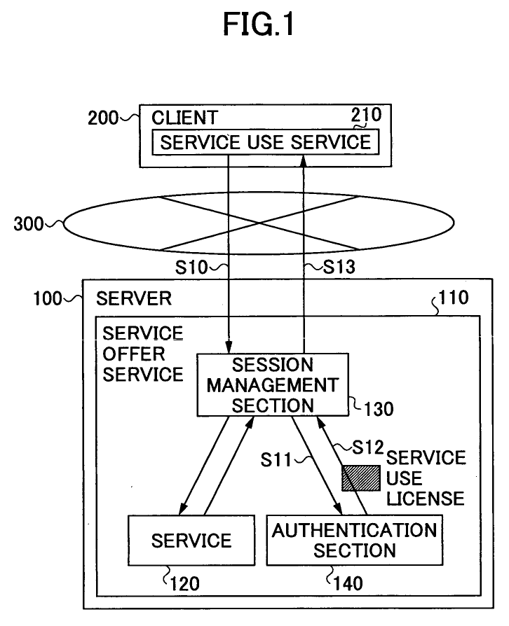

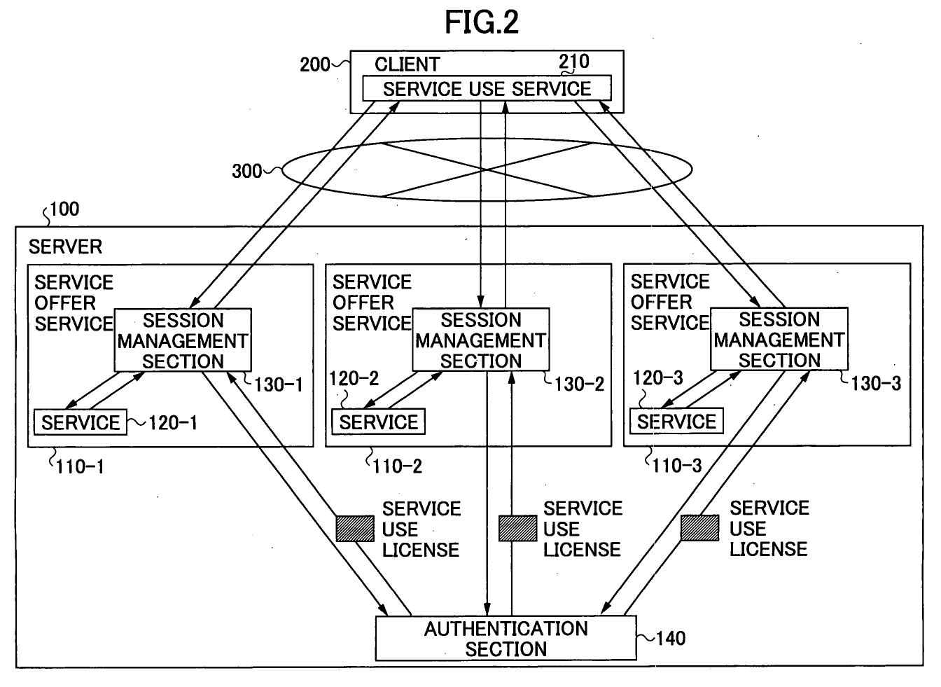

### DETAILED DESCRIPTION OF THE PREFERRED EMBODIMENTS

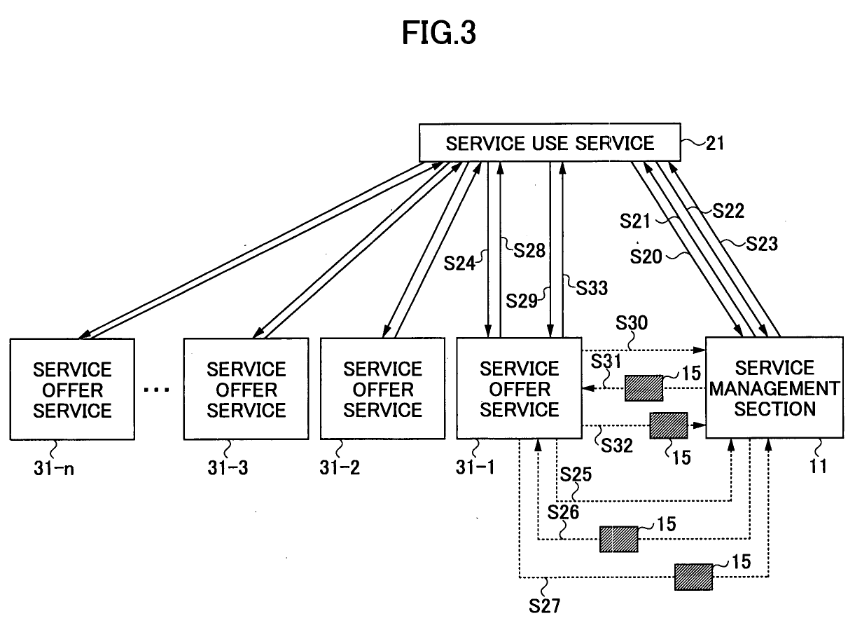

A description will now be given of a license management method and a service offer method according to embodiments of the present invention. FIG. 3 is a conceptual illustration for explaining the license management method and the service offer method according to the present invention.

In FIG. 3, when the service use service uses a service offered by the service offer service 31, the service use service 21 sends, first in step S20, to a service management service 11 a start request of a session between the service use service 21 concerned and a service management service.

The service management service 11 acquires a service use license 15 issued by an authentication section based on attestation information included in the start request of the acquired session, and produces and manages a first session object containing the service use license 15.

Following step S20, the routine proceeds to step S21 where the service management service 11 produces a session start response containing the first session ID 16 which discriminates a first session object 17 mentioned later and sends the produced session start response to the service use service 21.

Following step 21, the routine proceeds to step S22 where the service use service 21 produces a license acquisition request of a license ID 25 mentioned later which discriminates the service use license 15 by using the first session ID 16 acquired in step S21, and sends the produced acquisition request to the service management service 11.

Based on the first session ID 16 contained in the acquisition request of the license ID 25, the service management service 11 acquires the managed service use license 15, which has been acquired from the authentication section and managed, and produces the license ID 25 which discriminates the service use license 15 by using the service use license.

Following the step S22, the routine proceeds to step S23 where the service management service 11 produces a license ID acquisition response containing the license ID 25, and sends the ID acquisition response to the service use service 21.

Following step S24, the routine proceeds to step S24 where the service use service 21 sends to one of service offer services 31-1 to 31-n a start request of a session between the service use service 21 containing the license ID 25 acquired in step S23 and the one of the service offer services 31-1 to 31-n. Hereinafter, the one of the service offer services 31-1 to 31-n may be referred to as a service offer service 31.

Subsequent to step S24, the routine proceeds to step S25 where the service offer service 31 sends to the service management service 11 an acquisition request of the service use license 15 contained in the session start request acquired in step S24.

Subsequent to step S25, the routine proceeds to step S26 where the service management service 11 attests the license ID 25 contained in the acquisition request of the service use license 15 acquired in step S25. If it is determined the license ID 25 is effective, the service management service 11 sends to the service offer service 31 the result of the determination and the service use license 15 corresponding to the license ID 25.

The service offer service 31 performs initialization of services, etc. using the acquired service use license 15.

Following step S26, the routine proceeds to step S27 where the service offer service 31 sends the service use license 15 acquired in step S26 to the service management service 11.

Following step S27, the routine proceeds to step S29 where the service offer service 31 produces a session start response containing a second session ID 35 which discriminates a second session object 36 mentioned later, and sends the produced session start response to the service offer service 21.

Following step S29, the routine proceeds to step S28 where the service use service 21 produces a use request of the service containing the second session ID acquired in step S28, and sends the produced use request to the service offer service 31.

Following step S29, the routine proceeds to step S30 where the service offer service 31 acquires the license ID 25 corresponding to the second session ID contained in the use request of the service which was received in Step S29, and sends the acquisition request of the service use license 15 corresponding to the license ID 25 to the service management service 11.

Following step S30, the routine proceeds to step S31 where the service management service 11 attests the license ID 25 contained in the acquisition request of the service use license 15 acquired in step S30, and if it determined that the license ID 25 is effective, the service management service 11 sends to the service offer service 31 the result of the determination and the service use license 15 corresponding to the license ID 25.

Using the acquired service use license 15, the service offer service 31 performs a use request of service requested by the service use service 21, and acquires a use result.

Following step S31, the routine proceeds to step S32 where the service offer service 31 sends the service use license 15 acquired in step S31 to the service management service 11.

Following step S32, the routine proceeds to step S33 where the service offer service 31 produces a use response of service including the above-mentioned use result, and sends the use response to the service use service 21.

If the service use license 15 is shared with the service offer services 31-1 to 31-n shown in FIG. 3 simultaneously, by using the method explained with reference to FIG. 3, the service management service 11 just increments a value indicating the status of use of the service use license 15 when acquiring the service use license 15 from the authentication section.

Thus, the value indicating the status of use of the service use license can be prevented from being incremented each time the service use service 21 makes a session with the service offer services 31 and each time the service use service 21 sends a request to one of the service offer services 31-1 to 31-n to use a service.

Additionally, when use of the service use license 15 at one time is limited to only one of the service offer services 31-1 to 31-n, by using the method explained with reference to FIG. 3, the service management service 11 just increments a value indicating the status of use of the service use license 15 only for a period during which a request is sent from the service use service 21 to one of the service offer services 31-1 to 31-n and a response is sent from one of the service offer services 31-1 to 31-n to the service offer service 21.

Thus, the value indicating the status of use of the service use license 15 can be prevented from being incremented while a session is made between the service use service 21 and one of the service offer services 31-1 to 31-n. The service management service 11 shown in FIG. 3 and the service offer services 31-1 to 31-n may be operated in the same server or may be operated in different servers.

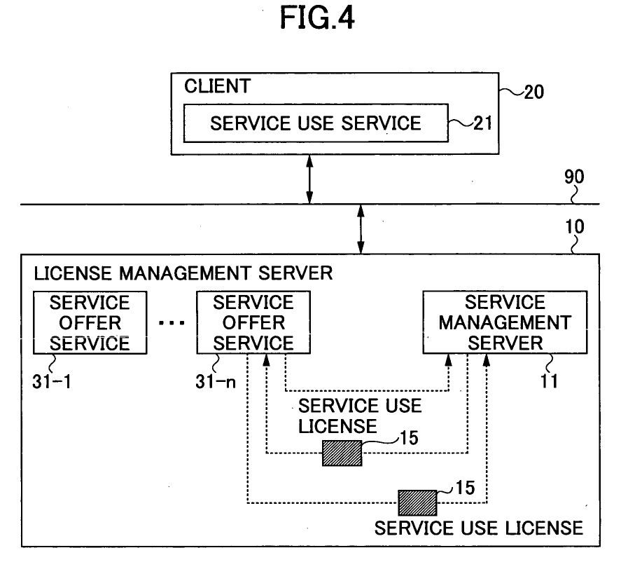

A description will be given below, with reference to FIG. 4 of an example of an operation wherein the service management service 11 and the service offer services 31 are operated in the same server. FIG. 4 is an illustration for explaining the example in which the service management service 11 and the service offer services 31 (31-1 to 31-n) are operated in the same server.

In FIG. 4, the service use service 21 operates in a client 20, and-the service management service 11 and the plurality of service offer services 31-1 to 31-n operate in a license management server 10. Moreover, the client 20 and the license management server 10 are connected through a network 90. The service use service 21 of the client 20 and the service management service 11 and the service offer services 31-1 to 31-n of the license management server 10 communicate with each other through the network 90, and the communication is performed based on a simple object access protocol (SOAP).

Moreover, the communication between the service management service 11 in the license management server 10 and the service offer services 31-1 to 31-n is performed based on a distributed component object model (DCOM).

It should be noted that the communication between the service management service 11 in the license management server and the service offer services 31-1 to 31-n may be performed based on SOAP.

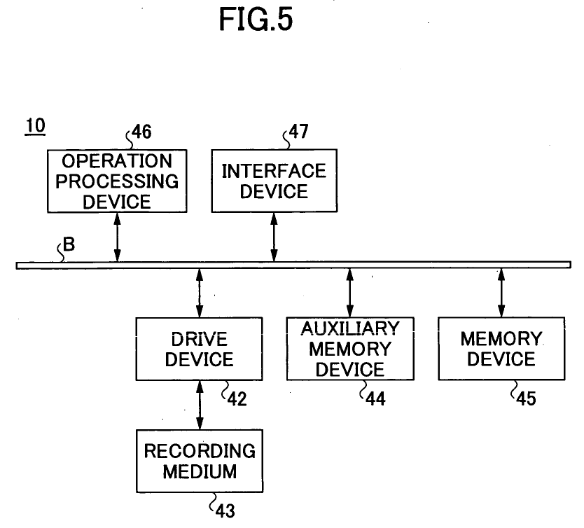

A description will be given below, with reference to FIG. 5, of the hardware structure of the example explained with reference to FIG. 4. FIG. 5 is a block diagram of the hardware of the example of the license management server explained with reference to FIG. 4.

The hardware structure shown in FIG. 5 comprises a drive device 42, a recording medium 43, an auxiliary memory device 44, a memory device 45, an operation processing device 46 and an interface device 47, which are connected with each other through a bus B. The interface device 47 is an interface for connecting the license management server 10 to the network 90.

Programs corresponding to the service management service 11 and the service offer services 31-1 to 31-n are provided to the license management server 10 by the recording medium 43 such as a CD-ROM, or downloaded through the network 90. The recording medium 43 is set in the drive device 42, and the programs corresponding to data, the service management service 11 and the service offer services 31-1 to 31-n are installed in the auxiliary memory 44 through the drive device 42 from the recording medium 43.

The auxiliary memory device 44 stores the programs corresponding to data, the service management service 11 and the service offer services 31-1 to 31-n, and also stores necessary files, etc.

The memory device 45 reads the programs corresponding to the service management service 11 and the service offer services 31-1 to 31-n from the auxiliary memory device at the time of starting the license management server 10, and stored the programs therein. The operation processing device 46 performs a process in accordance with the programs read and stored by the memory device 45.

It should be noted that the service management service 11 may have a structure containing the authentication section mentioned later, or may not have the authentication section. Moreover, the service offer services 31-1 to 31-n may have a structure which includes therein the service to be offered, or may not have such a structure.

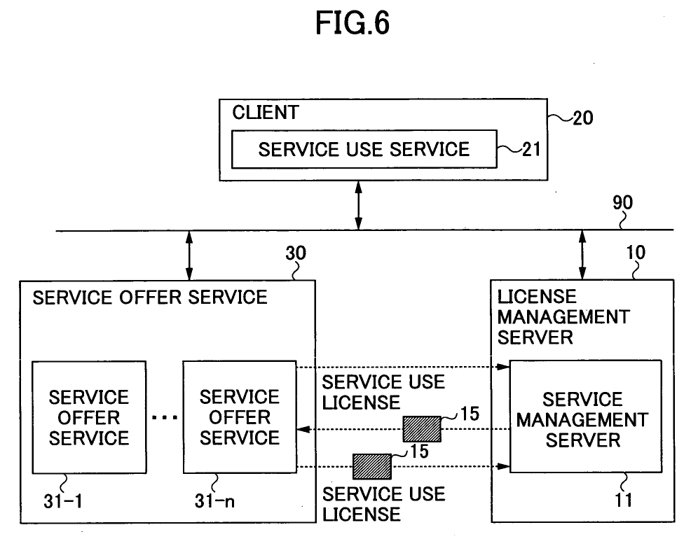

A description will now be given below, with reference to FIG. 6, of an example in which the service management service 11 and the service offer services 31-1 to 31-n operate in different servers. FIG. 6 is an illustration for explaining the example in which the service management service 11 and the service offer services 31-1 to 31-n operate in different servers. Hereinafter the plurality of service offer services 31-1 to 31-n may be referred to as service offer services 31 for the sake of convenience.

In FIG. 6, the service use service 21 operates in the client 20, and the plurality of service offer services 31 operate in a service offer server 30, and the service management service 11 operates in the license management server 10.

Moreover, the client 20, the service offer server 30 and the license management server 10 are connected through the network 90.

Communication between the service use service 21 of the client 20 and the service management service 11 of the license management server 10 is performed based on SOAP, and communication between the service use service 21 of the client 20 and the service offer services 31 of the service offer server 30 is also performed based on SOAP. Moreover, communication between the service offer services 31 of the service offer server 30 and the service management service 11 of the license management server 10 is performed based on DCOM. It should be noted that the communication between the service offer services 31 of the service offer server 30 and the service management service 11 of the license management server 10 may be based on SOAP.

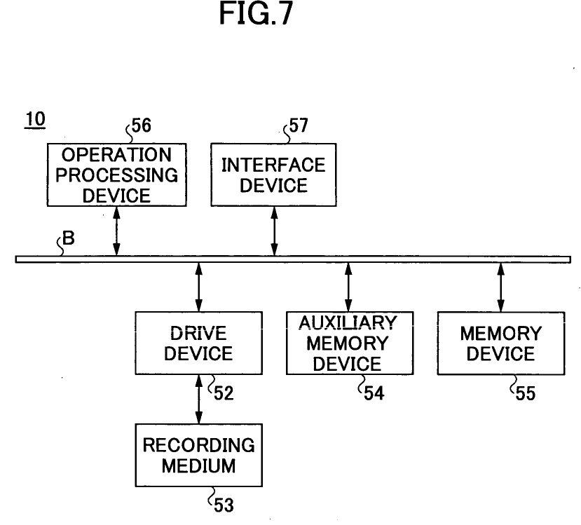

A description will now be given, with reference to FIG. 7, of hardware of the license management server explained with reference to FIG. 6. FIG. 7 is a hardware structural diagram of the license management server 10 explained with reference to FIG. 6.

The hardware structure shown in FIG. 7 comprises a recording medium 53, an auxiliary memory device 54, a memory device 55, an operation processing devices 56 and an interface device 57, which are connected to each other through a bus B.

The interface device 57 is an interface for connecting the license management server 10 to the network 90.

The license management server 10 is provided with programs corresponding to the service management service 11 by the recording medium 53 such as a CD-ROM, or the programs may be downloaded through the network 90. The recording medium 53 is set in the drive device 52, and the programs corresponding to data or the service management service 11 are installed in the auxiliary memory device 54 through the drive device 52 from the recording medium 53.

The auxiliary memory device 54 stores the programs corresponding to data or the service management service 11, and also stores necessary files, etc. The memory device 55 reads and stores the programs corresponding to the service management service 11 from the auxiliary memory device 54 at the time of starting an operation of the license management server 10. The operation processing device 56 performs a process in accordance with the programs corresponding to the service management service 11 stored in the memory device 55.

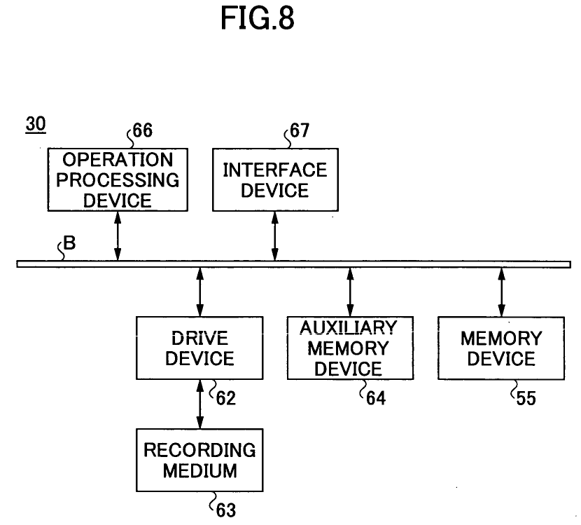

A description will now be given, with reference to FIG. 8, of hardware of the service offer server 30 explained with reference to FIG. 6. FIG. 8 is a hardware structural diagram of the service offer server explained with reference to FIG. 6.

The hardware structure shown in FIG. 8 comprises a recording medium 63, an auxiliary memory device 64, a memory device 65, an operation processing devices 66 and an interface device 67, which are connected to each other through a bus B.

The interface device 67 is an interface for connecting the service offer server 30 to the network 90.

The service offer server 30 is provided with programs corresponding to the service offer services 31 by the recording medium 63 such as a CD-ROM, or the programs may be downloaded through the network 90. The recording medium 63 is set in the drive device 62, and the programs corresponding to data or the service offer services 31 are installed in the auxiliary memory device 64 through the drive device 62 from the recording medium 63.

The auxiliary memory device 64 stores the programs corresponding to data or the service offer services 31, and also stores necessary files, etc. The memory device 65 reads and stores the programs corresponding to the service offer services 31 from the auxiliary memory device 64 at the time of starting an operation of the service offer server 30. The operation processing device 66 performs a process in accordance with the programs corresponding to the service offer services 31 stored in the memory device 65.

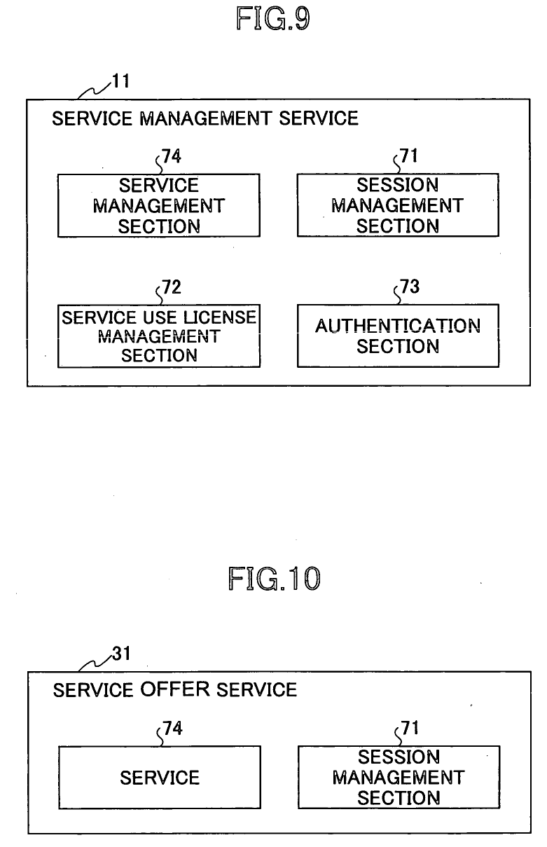

A description will be given below, with reference to FIG. 9, of a functional structure of an example of the service management service 11. FIG. 9 is a functional block diagram of the example of the service management service.

As shown in FIG. 9, the service management service 11 includes a session management section 71, a service use license management section 72, an authentication section 73 and a service management section 74.

The session management section 71 manages a session between the service management service 11 and the service use service 21. Moreover, the session management section 71 produces a first session object 17 mentioned later, and manages a first session ID 16 and the first session object 17 by relating to each other using a first session management table 18 mentioned later.

It should be noted that, in the example 1, the session management section 71 or a counting section contained in the session management section 71 performs a counting associated with the service use license 15. More specifically, in the example 1, when the service use license issued by the authentication section 73 is acquired, a value indicating a status of use of the service use license 15 is incremented. Additionally, for example, the value indicating a statue of use of the service use license 15 is decremented when an effective period of a session between the service use service 21 and the service management service 11 expires.

The service use license management section 72 manages the service use license 15. Moreover, the service use license management section 72 produces a license ID 25 which discriminates the service use license 15 based on the service use license 15, and manages the license ID 25 and the service use license 15 by relating to each other using a license ID management table 26 mentioned later.

It should be noted that, in the second embodiment mentioned later, the service use license management section 72 or a counting section contained in the service use license management section 72 performs a counting associated with the service user license 15. More specifically, when the service management service 11 or the service use license management section 72 sends the service use license 15 to the service offer services 31 based on a request from the service offer services 31, the value indicating the status of use of the service use license 15 is incremented. Moreover, the value indicating the status of use of the service use license 15 is decremented when the service use license 15 is returned from the service offer services 31.

The authentication section 73 performs an authentication according to authentication information such as a user name or a password sent from the service use service 21, and issues the service use license 15. It should be noted that the authentication section 73 may exist in the service management service 11 as shown in FIG. 9, or may exist outside the service management service 11.

Hereinafter, for the sake of simplification, a description will be given on the assumption that the authentication section 73 exists in the service management service 11.

The service management section 74 manages information regarding the service offer services 31, which the service management service 71 manages, such as URL of the service offer services 31 concerned.

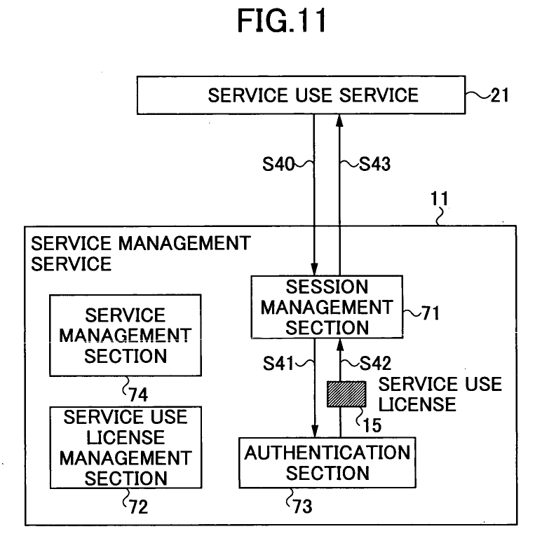

A description will be given below, with reference to FIG. 10, of a functional structure of an example of the service offer services 31. FIG. 10 is a functional block diagram of an example of the service offer services.

As shown in FIG. 10, each of the service offer services 31 includes a session management section 81 and a service 82..

The session management section 81 manages a session between the service offer service 31 and the service use service 21. Moreover, the session management section 81 produces a second session object 36 mentioned later, and manages a second session ID 35 and the second session object 36 by relating to each other using a second session management table 27 mentioned later.

The service 82 is a service, which is provided from the service offer service 31 concerned to the service use service 21. For example, the service 82 includes a printing service for performing printing, an image conversion service for performing a format conversion of an image file, a scanning service for scanning a document, a directory service for storing personal information, a distribution service fro offering a function of mail, FAX, etc., and a document accumulation service for accumulating documents.

It should be noted that the service 82 may exist in the service offer service 30 as shown in FIG. 10, or may exist outside the service offer services 31. Hereinafter, for the sake of simplification, a description will be given on the assumption that the service 82 exists in the service offer services 31 unless particularly mentioned.

### First Embodiment

A description will now be given, with reference to FIGS. 11 through 33, of a first embodiment of the present invention.

FIG. 11 is an illustration for explaining an example of a start procedure of a session between the service use service and service management service.

As explained with reference to FIG. 3, when the service use service 21 use a service which the service offer services 31 offer, the service use service 21 first sends to the service management service 11 a start request (hereinafter referred to as a first session start request) of a session with the service management service 11.

In step S40, the session management section 71 receives the first session start request sent from the service use service 21.

Following step S40, the routine proceeds to step S41 where the session management section 71 sends to the authentication section 73 a service use license issue request which contains a user ID, a password, etc., which are contained in the session start request received in step S40.

Following step S41, the routine proceeds to step S42 where the session management section 71 receives the service use license 15 issued by the authentication section. Upon receipt of the service use license 15 from the authentication section 73, the session management section 71 increments the value indicating the status of use of the service use license 15.

The session management section 71 produces a first session object 17 mentioned later, and adds the service use license 15 acquired in step S42 to the first session object 17. The session management section also adds the first session object 17 to a first session management table 18 mentioned later.

Following step S42, the routine proceeds to step S43 where the session management section 71 sends to the service use service 21 a response of a session start containing the first session ID 16 which indicates a permission of use of the service management service 11.

A description will now be given, with reference to FIG. 12, of an example of the first session start request. FIG. 12 is an illustration for explaining an example of the first session start request. As shown in FIG. 12, communication between the service use service 21 and the service management service 11 is performed based on SOAP.

The authentication method is provided between the tags <scheme> and </scheme> as shown in FIG. 12. A user ID is provided between tags <userid> and </userid>. A password is provided between tags <password> and </password>. Moreover, an effective time of a session defined by second as a unit is provided between tags <timeLimit> and </timeLimit>.

The session management section 71 sends the information stored by the tags to the authentication section 73, and acquires the service use license 15.

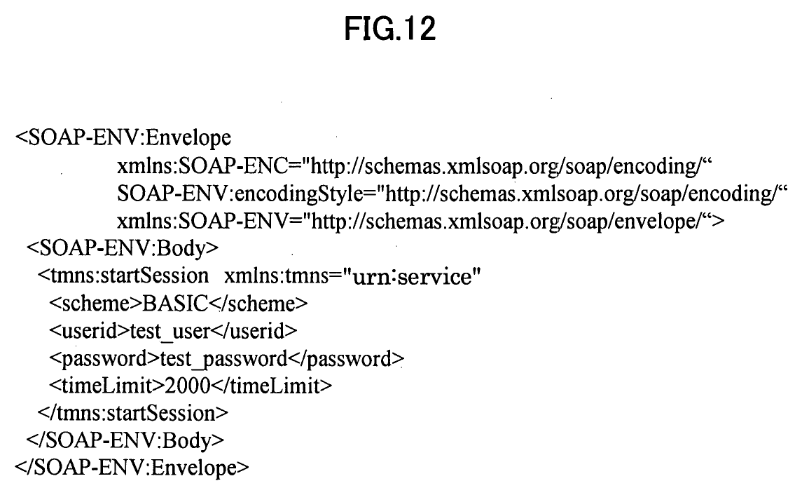

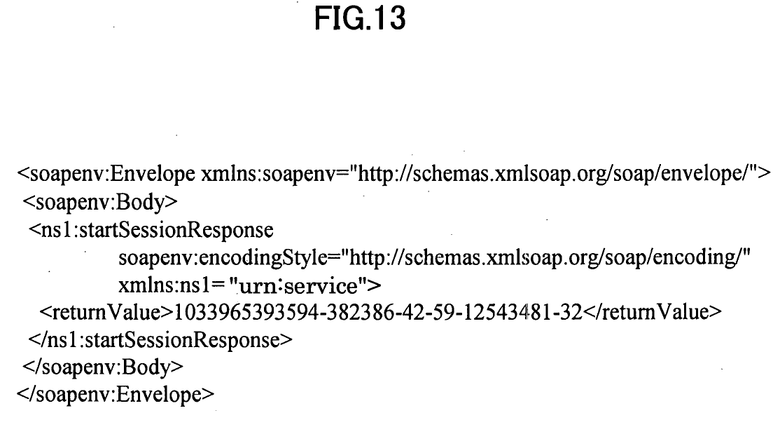

A description will now be given below, with reference to FIG. 13, of an example of the first session start response. FIG. 13 is an illustration for explaining an example of the first session start response.

The first session ID 16 is provided between tags <returnValue> and </returnValue> as shown in FIG. 13.

The service use service 21, which acquired the first session ID 16, is able to use the service management service 11 by using the first session ID 16 during the period provided between tags <timeLimit> and </timeLimit>> of the first session start request of FIG. 12.

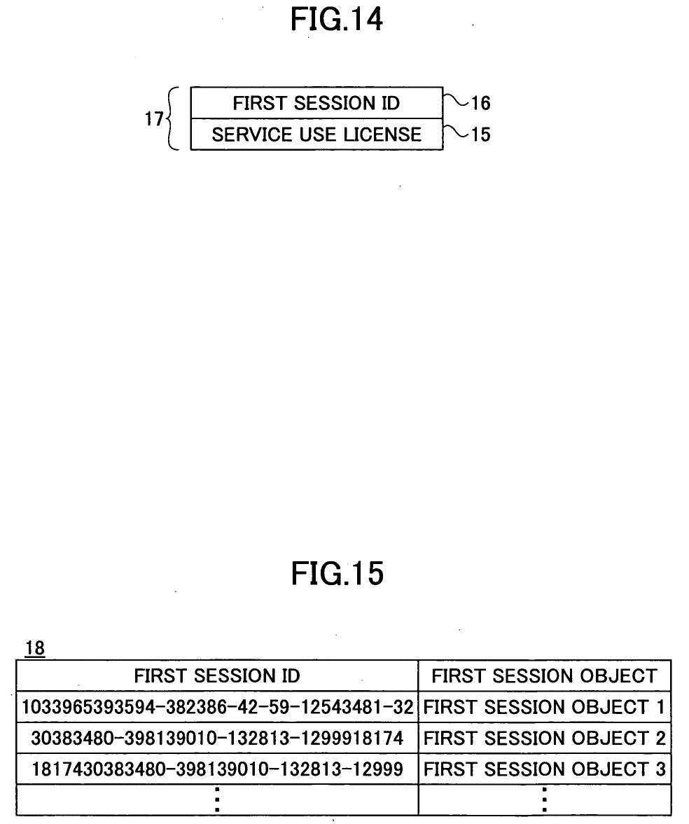

A description will now be given, with reference to FIG. 14, of an example of a structure of the first session object 17. FIG. 14 is an illustration for explaining an example of the structure of the first session object.

As shown in FIG. 14, the first session object 17 holds the first session ID 16 and the service use license 15 as one object.

The session management section 71 adds the service use license 15 acquired from the authentication section 73 to the first session object 17 shown in FIG. 14. Moreover, the session management section 71 adds the first session object 17, to which the service use license 15 is added, to a first session management table 18 shown in FIG. 15 mentioned later.

A description will be given below, with reference to FIG. 15, of an example of a structure of the first session management table 18. FIG. 15 is an illustration for explaining an example of the structure of the first session management table.

The first session management table 18 shown in FIG. 15 is a table which relates the first session ID 16 to the first session object 17. The first session management table 18 is included, fro example, in the session management section 71.

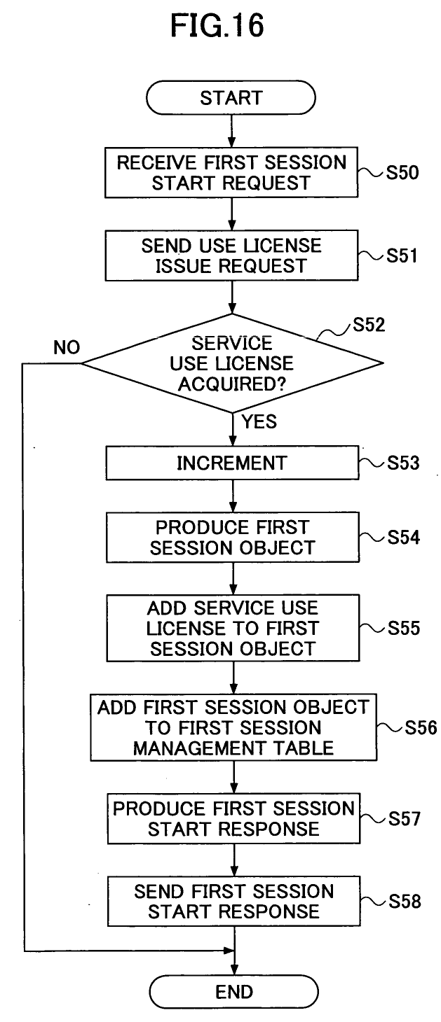

A description will be given below, with reference to FIG. 16, of an example of a start process of a session between the service use service 21 and the service management service 11. FIG. 16 is the flowchart of an example of a start process of a session between the service use service and the service management service.

In step S50, the session management section 71 receives from the service use service 21 the first session start request as shown in FIG. 12 including authentication information. It should be noted that the authentication information refers to, for example, the data provided between the <scheme> tags, the <userid> tags, the <password> tags, the <timeLimit> tags, etc., shown in FIG. 12.

Following step S50, the routine proceeds to S51 where the session management section 71 sends an issue request of the service use license 15 to the authentication section 73 by using the authentication information included in the first session start request received in step S50.

Following step S51, the routine proceeds to S52 where the session management section 71 determines whether or not the service use license 15 has been acquired from the authentication section 73. If the session management section 71 determines that the service use license has been acquired from the authentication section 73 (YES in step S52), the routine proceeds to step S53. On the other hand, if the authentication information is not right, if it is determined that the service use license has not been received (NO in step S52), it is determined that the authentication information is no correct, and the routine is ended.

In step S53, the session management section 71 increments the value indicating the status of use of the service use license 15 by one.

Following step S53, the routine proceeds to step S54 where the session management section 71 produces the first session object 17 as shown in FIG. 14.

Following step S54, the routine proceeds to step S55 where the session management section 71 adds the service use license 15 acquired in step S52 to the first session object 17 produced in step S53.

Following step S55, the routine proceeds to step S56 where the session management section 71 adds the first session object 17, to which the service use license 15 is added in step S54, to the first session management table 18 shown in FIG. 15.

Following step S56, the routine proceeds to step S57 where the session management section 71 produces the first session start response containing the first session ID 16 shown in FIG. 13.

Following step S57, the routine proceeds to step S58 where the session management section 71 sends the first session start response produced in step S57 to the requesting service use service 21.

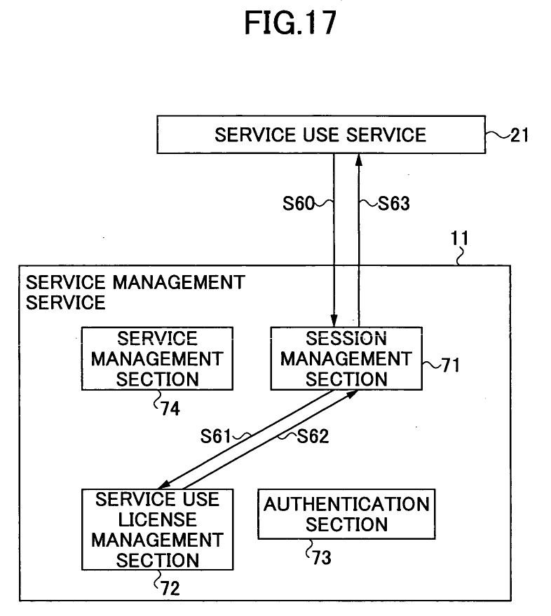

A description will be given below, with reference to FIG. 17, of an example of a procedure of acquiring the license ID. FIG. 17 is an illustration for explaining a procedure of acquiring the license ID.

As explained with reference to FIG. 11 and FIG. 16, the service use service 21 acquires from the service management service 11 the first session ID 16 which is a right to use the service management service 11. The service use service 21 sends an acquisition request of the license ID 25 to the service management service 11 using the first session ID 16.

In step S60, the session management section 71 receives the license ID acquisition request sent from the service use service 21. The session management section 71 determines whether or not the first session ID 16 contained in the license ID acquisition request is effective. If the first session ID 16 is effective, the session management section 71 acquires a corresponding first session object 17 from the first session management table 18 shown in FIG. 15. Additionally, the session management section 71 acquires the service use license 15 from the acquired first session object 17.

Following step S60, the routine proceeds to step S61 where the session management section 71 sends to the service use license management section 72 the acquisition request of the license ID 25 containing the acquired service use license 15. Upon reception of the request, the service use license management section 72 produces the license ID 25 corresponding to the service use license 15, and registers the produced license ID 25 and the service use license 15 contained in the acquisition request of the license ID 25 in a license ID management table mentioned later.

Following step S61, the routine proceeds to step S62 where the session management section 71 receives the license ID 25 sent from the service use license management section 72.

Following step S62, the routine proceeds to step S63 where the session management section 71 sends a license ID acquisition response containing the license ID 25 to the service use service 21.

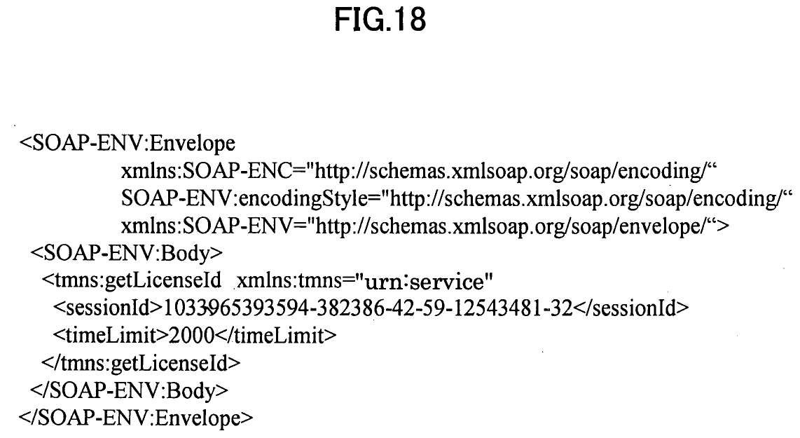

A description will be given below, with reference to FIG. 18, of an example of the license ID acquisition request. FIG. 18 is an illustration for explaining an example of the license ID acquisition request.

The first session ID 16 acquired in the first session start response of FIG. 13 is provided between tags <sessionId> and </sessionId>> shown in FIG. 18. An effective period of the license ID 25 defined by second as a unit is provided between tags <timeLimit> and </timeLimit>.

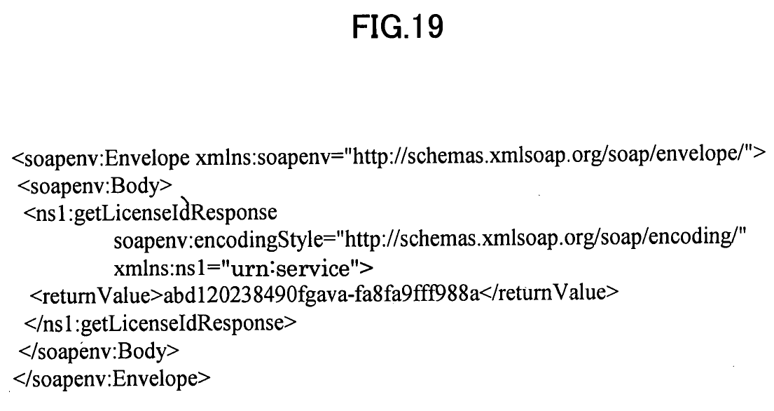

A description will be given below, with reference to FIG. 19, of an example of the license ID acquisition response. FIG. 19 is an illustration for explaining an example of the license ID acquisition response.

The license ID 25 is provided between tags <returnValue> and </returnValue>> as shown in FIG. 19. The service use service 21, which acquired the license ID 25, is able to send an effective request for establishing a session with the service offer services 31 for the period provided between tags <timeLimit> and </timeLimit>> of FIG. 18.

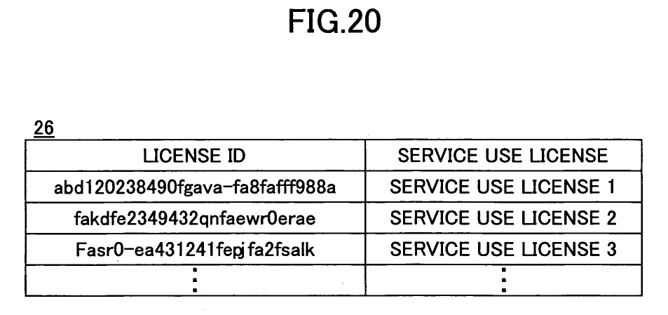

A description will be given below, with reference to FIG. 20, of an example of the license ID management table 26. FIG. 20 is an illustration for explaining an example of a structure of the license ID management table.

The license ID management table 26 shown in FIG. 20 is a table which relates the license ID 25 to the service use license 15.

As explained with reference to FIG. 17, the service use license management section 72 produces the license ID 25 when the service use license 15 is received from the session management section 71, and registers the produced license ID 25 and the service use license 15 in the license ID management table 26. It should be noted that the license ID management table 26 is included, for example, in the service use license management section 72.

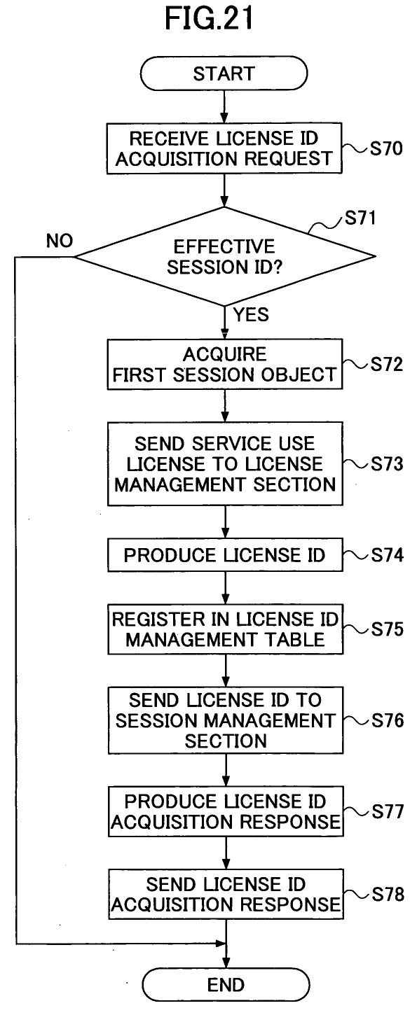

A description will be given below, with reference to FIG. 21, of an example of a license ID acquisition process. FIG. 21 is a flowchart of an example of a license ID acquisition process.

As explained with reference to FIG. 17, when the service use service 21 acquires the first session ID 16 from the service management service 11, the service use service 21 sends a license ID acquisition request to the service management service 11 by using the first session ID 16.

In step S70, the session management section 71 receives the license ID acquisition request such as shown in FIG. 18, which contains the first session ID 16, from the service use service 21.

Following step S70, the routine proceeds to step S71 where the session management section 71 determined whether or not the first session ID 16 contained in the license ID acquisition request acquired in step S70 is effective. If it determined that the session ID is effective (YES in step S71), the routine proceeds to step S72. On the other hand, if it is determined that the session ID is not effective (NO in step S71) the process is ended.

In step S72, the session management section 71 acquires the first session object 17 corresponding to the first session ID 16 contained in the license ID acquisition request from the first session management table 18 shown in FIG. 15.

Following step S72, the routine proceeds to step S73 where the session management section 71 acquires the service use license 15 from the first session object 17 acquired in step S72, and sends the acquired service use license 15 to the service use license management section 72.

Following step S73, the routine proceeds to step S74 where the service use license management section 72 produces the license ID 25 which discriminates the service use license 15 based on the service use license 15 acquired in step S73.

Following step S74, the routine proceeds to step S75 where the service use license management section 72 registers the service use license 15 and the license ID 25 produced in step S74 into the license ID management table 26 shown in FIG. 20.

Following step S75, the routine proceeds to step S76 where the service use license management section 72 sends the license ID 25 to the session management section 71.

Following step S76, the routine proceeds to step S77 where the session management section 71 produces a license ID acquisition response such as shown in FIG.19 containing the license ID 25 which was received in step S76.

Following step S77, the routine proceeds to step S78 where the session management section 71 sends the license ID acquisition response produced in step S77 to the service use service 21.

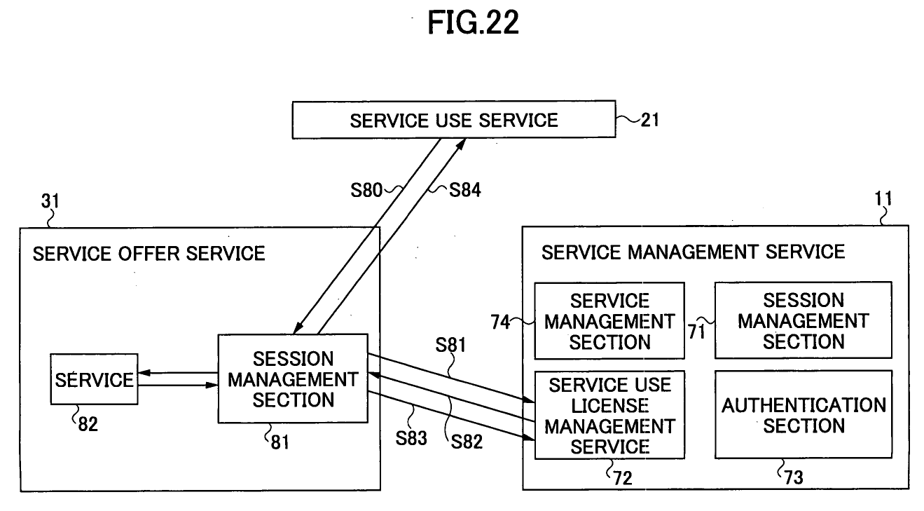

A description will be given below, with reference to FIG. 22, of an example of a start procedure of a session between the service use service 21 and the service offer services 31. FIG. 22 is an illustration for explaining an example of a start procedure of a session between the service use service and the service offer service.

As explained with reference to FIG. 17 and FIG. 21, the service use service 21 acquires the license ID 25 from the service management service 11. The service use service 21 sends to the service offer service 31 a permission request (hereinafter, referred to as a second session start request) of the service offer service 31 using the license ID 25.

In step S80, the service offer service 31 receives the second session start request sent from the service use service 21.

Following step S80, the routine proceeds to step S81 where the session management section 81 sends to the service use license management section 72 the acquisition request for~the service use license containing the license ID 25 contained in the second session start request acquired in step S80.

Following step S81, the routine proceeds to step S82 where the service use license management section 72 performs an authentication of the license ID 25 contained in the acquisition request of the service use license 15 sent from the session management section 81. If it is determined that the license ID 25 is effective, the service use license management section 72 sends the result of determination and the service use license 15 corresponding to the license ID 25 to the session management section 81.

The session management section 81 performs predetermined processes such as an initialization of the service 82 using the received service use license 15. Moreover, the session management section 81 adds the license ID 25 to the produced second session object 36, and adds the second session object to a second session management table 37 mentioned later.

Following step S82, the routine proceeds to step S83 where the session management section 81 sends the service use license 15 to the service use license management section 72.

Following step S83, the routine proceeds to step S84 where the session management section 81 produces a second session start response containing the second session ID 35 which indicates a permission of use of the service offer service 31, and sends the second session start response to the service use service 21.

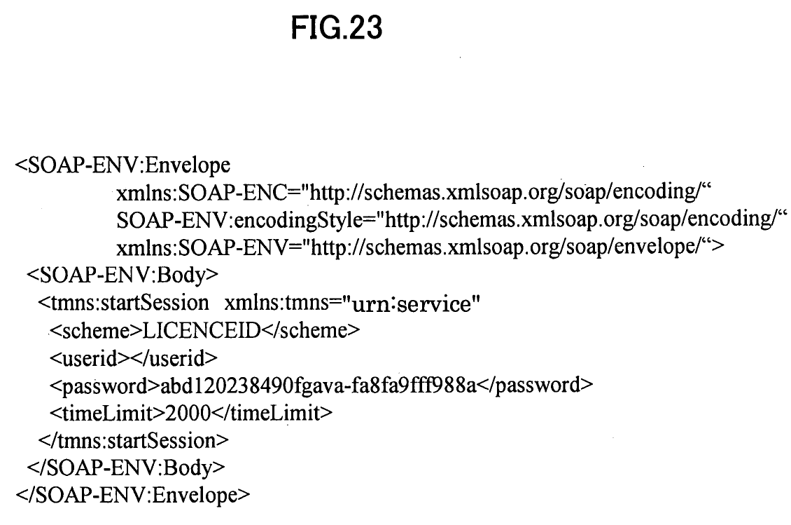

A description will be given below, with reference to FIG. 23, of an example of the second session start request. FIG. 23 is an illustration for explaining an example of the second session start request.

As shown in FIG. 23, communication between the service use service 21 and the service offer service 31 is performed based on SOAP. The authentication method is provided between tags <scheme> and </scheme> as shown in FIG. 23. The license ID 25 acquired by the service use service 21 using the license ID acquisition response shown in FIG. 19 is provided between tags <password> and </password>. Moreover, an effective period of a session between the service use service 21 and the service offer service 31 defined by second as a unit is provided between tags <timeLimit> and </timeLimit>.

The session management section 81 sends the license ID 25 provided between the tags <password> and </password> to the service use license management section 72, and authenticates whether or not the license ID 25 is effective.

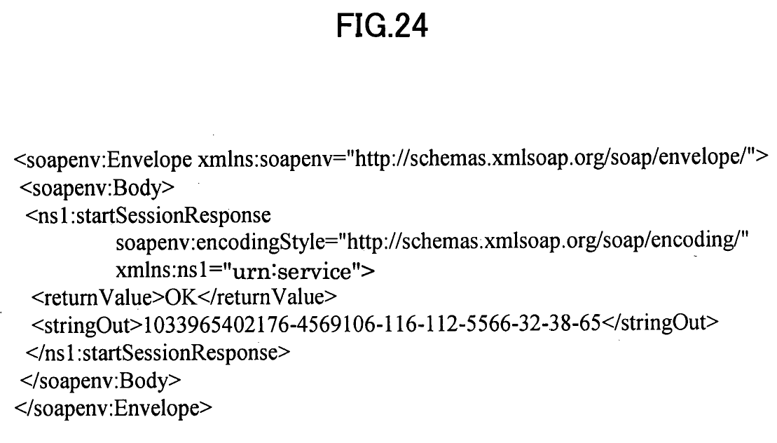

A description will be given below, with reference to FIG. 24, of an example of the second session start response. FIG. 24 is an illustration for explaining an example of the second session start response.

The second session ID 35 is provided between tags <stringOut> and </stringOut> as shown in FIG. 24. The service use service 21, which acquired the second session ID 35, is able to use the service offer service 31 by using the second session ID 35 during the period provided between the tags <timeLimit> and </timeLimit> of the second session start request of FIG. 23.

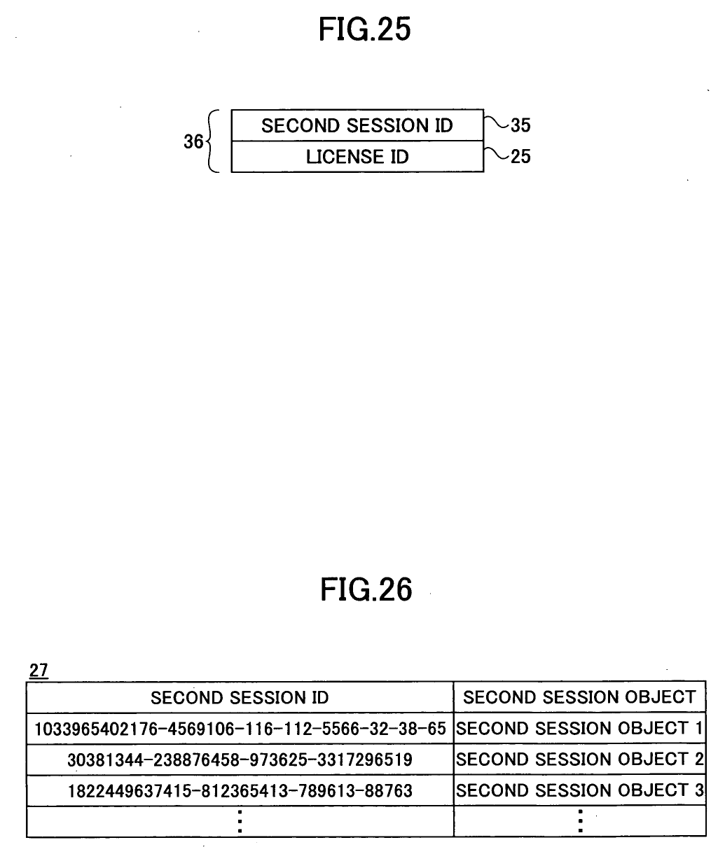

A description will be given below, with reference to FIG. 25, of an example of a structure of the second session object 36. FIG. 25 is an illustration for explaining an example of the structure of the second session object.

As shown in FIG. 25, the second session object 36 holds the second session ID 35 and the license ID 25 as one object. The session management section 81 authenticates the license ID 25 contained in the second session start request acquired from the service use service 21, and, thereafter, adds the license ID 25 to the second session object 36. The session management section 81 adds the second session object 36, to which the license ID 25 is added, to the second session management table 27 shown in FIG. 26.

A description will be given below, with reference to FIG. 26, of an example of a structure of the second session management table 27. FIG. 26 is an illustration for explaining an example of the structure of the second session management table.

The second session management table 27 shown in FIG. 26 is a table which relates the second session ID 35 to the second session object 36. The second session management table 27 is included, for example, in the session management section 81.

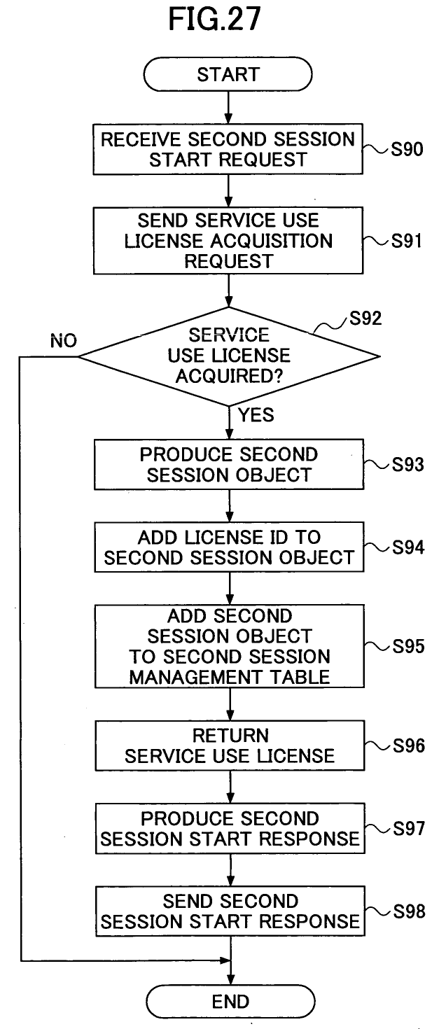

A description will be given below, with reference FIG. 27, of an example of a start process of a session between the service use service 21 and the service offer service 31. FIG. 27 is a flowchart of an example of a start process of a session between the service use service and the service offer service.

In step S90, the session management section 81 receives from the service use service 21 the second session start request such as shown in FIG. 23 which contains the license ID 25.

Following step S90, the routine proceeds to step S91 where the session management section 81 sends an acquisition request of the service use license 15 to the service use license management section 72 using the license ID 25 contained in the second session start request received in step S90.

Following step S91, the routine proceeds to step S92 where the session management section 81 determines whether or not the service use license 15 has been acquired from the service use license management section 72. If it is determined by the session management section 81 that the service use license 15 has been acquired from the service use license management section 72 (YES in step S92), the routine proceeds to step S93. On the other hand, if it is determined that the service use license 15 has not been acquired, it is determined that the license ID 25 is not correct, and the process is ended.

In step S93, the session management section produces the second session object 36 as showen in FIG. 25. Following step S93, the routine proceeds to step S94 where the session management section 81 adds the license ID 25 acquired in step S90 to the second session object 36 produced in step S93.

Following step S94, the routine proceeds to step S95 where the session management section 81 adds the second session object 36, to which the license ID 25 is added in step S93, to the second session management table 27 shown in FIG. 26.

Following step S95, the routine proceeds to step S95 where the session management section 81 returns the service use license 15 acquired in step S92 to the service use license management section 72.

Following step S96, the routine proceeds to step S97 where the session management section 81 produces a second session start response containing the second session ID 35 such as shown in FIG. 24.

Following step S97, the routine proceeds to step S98 where the session management section 81 sends the second session start response produced in step S97 to the service use service 21.

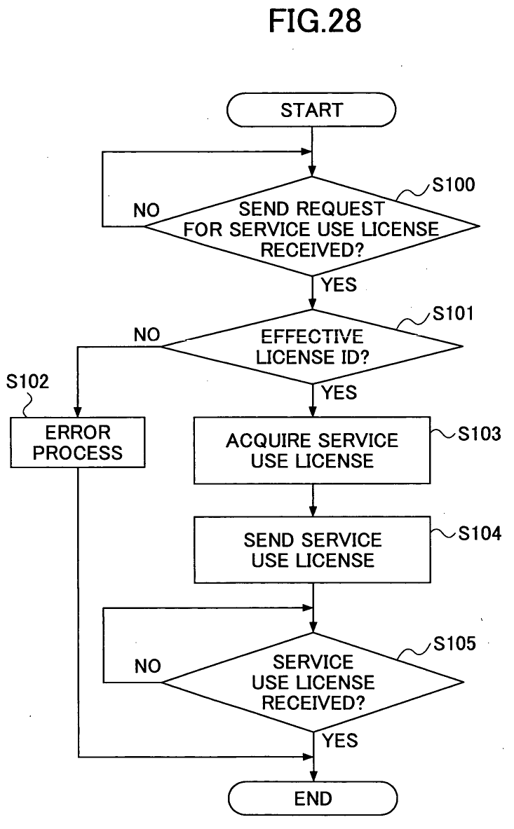

A description will be given below, with reference to FIG. 28, of an example of a license ID authentication process in the service management service 11. FIG. 28 is a flowchart of an example of the license ID authentication process in the service management service.

In step S100, the service use license management section 72 determines whether or not a acquisition request of the service use license 15 has been received from the service offer service 31. If it is determined by the service use license management section 72 that the acquisition request of the service use license 15 has been received (YES in step S100), the routine proceeds to step S101. On the other hand, if it is determined that the acquisition request of the service use license 15 has not been received (NO in step S100), the process of step S100 is repeated.

In step S101, the service use license management section 72 determines whether or not the license ID 25 contained in the acquisition request of the service use license 15 which has been received from the service offer service 31 is effective. If it is determined by the service license management section 72 that the license ID 25 is effective (YES in step S101), the routine proceeds to step S103. On the other hand, if it is determined that the license ID 25 is not effective (NO in step S101), the routine proceeds to step S102.

In step S102, the service use license management section 72 sends to the session management section 81 information indicating that the acquired license ID 25 is not effective, and the process is ended.

In step S103, the service use license management section 72 acquires the service use license 15 from the license ID management table 26 shown in FIG. 20 based on the license ID 25.

Following step S103, the routine proceeds to step S104 where the service use license management section 72 sends the corresponding service use license 15 acquired in step S103 to the session management section 81.

Following step S104, the routine proceeds to step S105 where the service use license management section 72 determines whether or not the service use license, which was sent to the session management section 81 in step S104, has been returned from the session management section 81. If it is determined by the service use license management section 72 that the service use license 15 has been returned from the session management section 81 (YES in S105), the process is ended. On the other hand, if it is determined that the service use license has not been returned (NO in step S105), the process of step S105 is repeated.

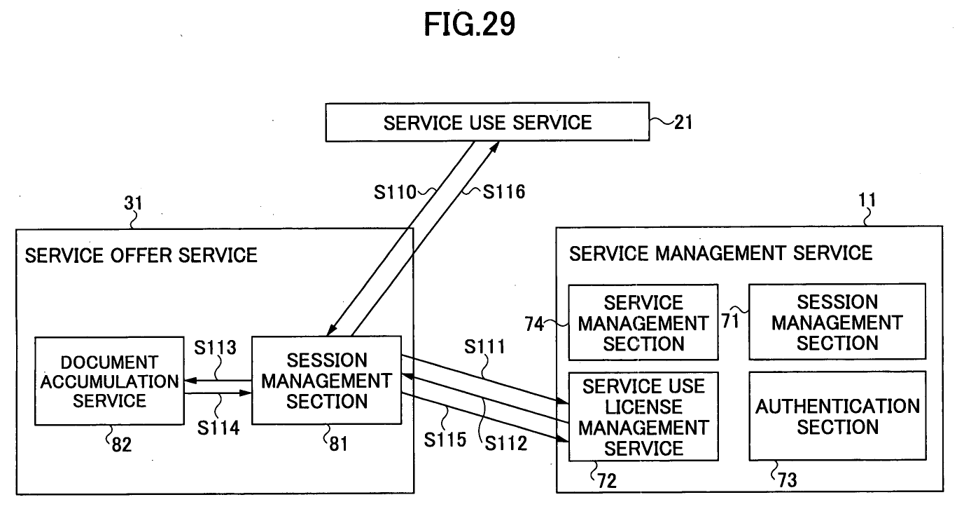

A description will be given below, with reference to FIG. 29 through FIG. 33, of the service 82 on the assumption that the service 82 is a document accumulation service (document repository service). FIG. 29 is an illustration for explaining an example of an accumulated document acquisition procedure.

As explained with reference to FIGS. 22 and 27, the service use service 21 acquires the second session ID 35 from the service offer service 31, the second session ID corresponding to a use permission of the service offer service 31.

The service use service 21 sends an acquisition request of accumulated documents (hereinafter, referred to as an accumulated document acquisition request) to the service offer service 31 using the second session ID 35. In step S110, the service offer service 31 receives the accumulated document acquisition request sent from the service use service 21. The session management section 81 acquires the corresponding second session object 36 from the second session management table 27 shown in FIG. 26 based on the second session ID 35 contained in the accumulated document acquisition request. Moreover, the session management section 81 acquires the license ID 25 from the acquired second session object 36.

Following step S110, a session management section 81 sends to the service use license management section 72 an acquisition request of the service use license 15 corresponding to the acquired license ID 25.

Following step S111, the routine proceeds to step 5112 where the service use license management section 72 authenticates the license ID 25 contained in the acquisition request of the service use license 15 sent from the session management section 81. If it is determined that the license ID 25 is effective, the service use license management section 72 acquires the corresponding service use license 15 from the license ID management table 26 of FIG. 20, and sends the above-mentioned result of determination and the service use license 15 to the session management section 81.

Following step S112, the routine proceeds to step S113 where the session management section 81 sends to a document accumulation service 82 an acquisition request of an accumulated document designated by the accumulated document acquisition request received in step S110 using the service use license 15 received in step S112.

Following step S113, the routine proceeds to step S114 where the session management section 81 acquires the accumulated document requested in step S113 from the document accumulation service 82. Following step S114, the routine proceeds to step S115 where the session management section 81 sends the service use license 15 to the service use license management section 72. Following step S115, the routine proceeds to step S116 where the session management section 81 produces an accumulated document acquisition response containing the accumulated document acquired in step S114, and sends the accumulated document acquisition response to the service use service 21.

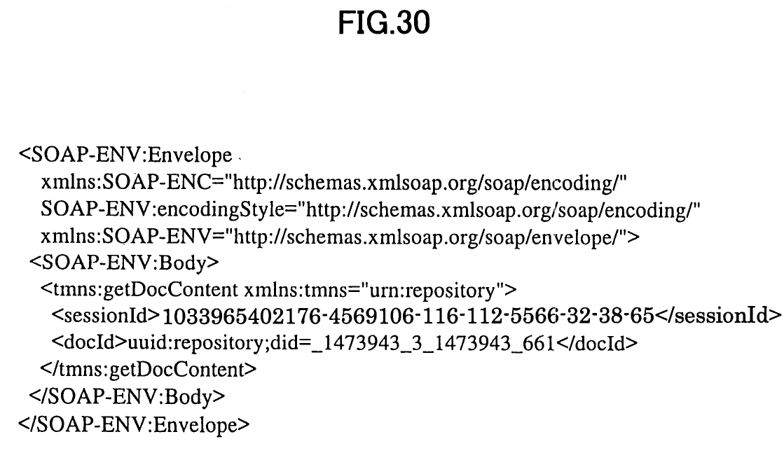

A description will be given below, with reference to FIG. 30, of an example of the accumulated document acquisition request. FIG. 30 is an illustration for explaining an example of the accumulated document acquisition request.

The second session ID 35 acquired by the service use service 21 using the second session start response of FIG. 24 is provided between tags <sessionId> and </sessionId> shown in FIG. 30. Data which discriminates the accumulated document to acquire is provided between tags <docId> and </docId>. The session management section 81 acquires the accumulated document indicated by the data, which discriminates the accumulated document and is provided between the tags <docId> and </docId>, from the document accumulation service 82 using the service use license 15.

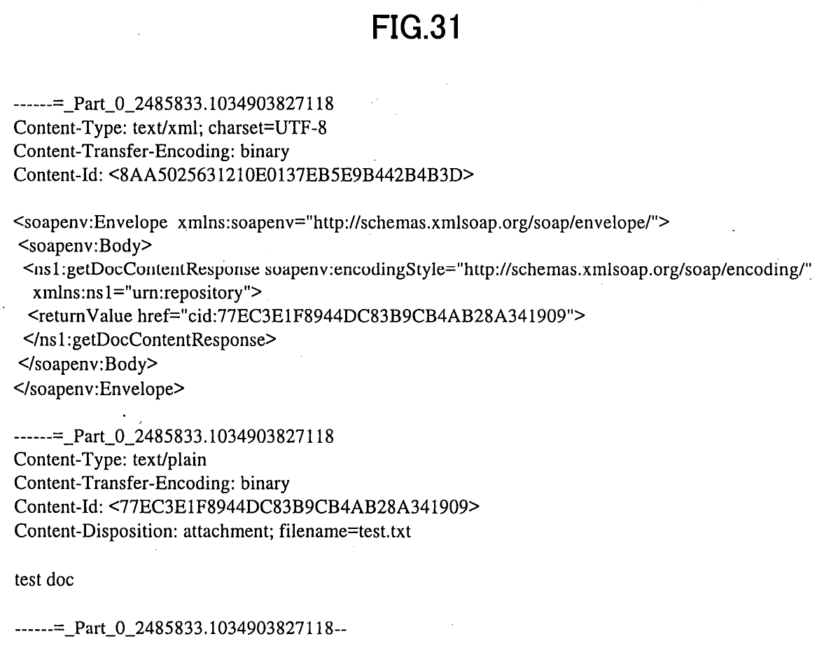

A description will be given below, with reference to FIG. 31, of an example of the accumulated document acquisition response. FIG. 31 is an illustration for explaining an example of the accumulated document acquisition response.

The data which discriminates the acquired accumulates document is stored in “returnValue” provided between tags <nsl:getDocContentResponse> and </nsl:getDocContentResponse> shown in FIG. 31. Moreover, information regarding the acquired accumulated document and contents of the document are described between and below tags <soapenv:Envelope> and </soapenv:Envelope>.

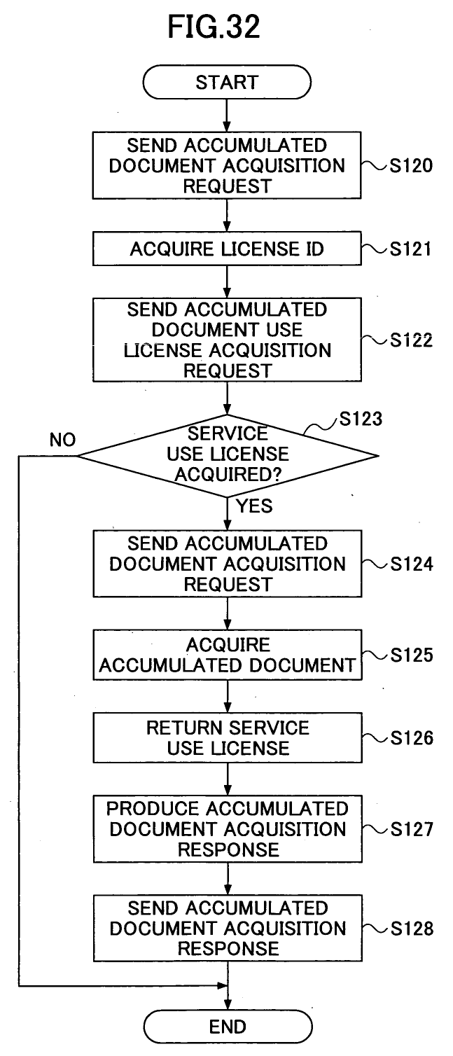

A description will be given below, with reference to FIG. 32, of an example of the accumulated document acquisition process in the service offer service 31. FIG. 32 is a flowchart of an example of the accumulated document acquisition process in the service offer service.

In step S120, the session management section 81 receives an accumulates document acquisition request as shown in FIG. 30 containing the second session ID 35 from the service use service 21.

Following step S120, the routine proceeds to step S121 where the session management section 81 acquires the corresponding second session object 36 from the second session management table 27 of FIG. 26 using the second session ID 35 contained in the accumulated document acquisition request received in step S120, and also acquires a license ID 25 from the second session object 36.

Following step S121, the routine proceeds to step S122 where the session management section 81 sends an acquisition request of the service use license 15 to the service use license management section 72 using the license ID 25 acquired in step S121.

Following step S122, the routine proceeds to step S123 where the session management section 81 determines whether or not the service use license 15 has been acquired from the service use license management section 72. If it is determined by the session management section 81 that the service use license has been acquired from the service use license management section 72 (YES in step S123), the routine proceeds to step S124. On the other hand, if it is determined that the service use license has not been acquired (NO in step S123), it is determined that the license ID 25 is not correct, and the process is ended.

In step S124, the session management section 81 sends to the document accumulation service 82 an acquisition request of the accumulated document designated by the accumulated document acquisition request received in step S120 by using the service use license 15 acquired in step S123.

Following step S124, the routine proceeds to step S125 where the session management section 81 acquires the accumulated document requested in step S124 from the document accumulation service 82. Following step S125, the routine proceeds to step S126 where the session management section 81 returns the service use license 15 acquired in step S123 to the service use license management section 72.

Following step S126, the routine proceeds to step S127 where the session management section 81 produces an accumulated document acquisition response such as shown in FIG. 31 containing the accumulated document acquired from the document accumulation service 82 in step S125. Following step S127, the routine proceeds to step S128 where the session management section 81 sends the accumulated document acquisition response produced in step S127 to the service use service 21.

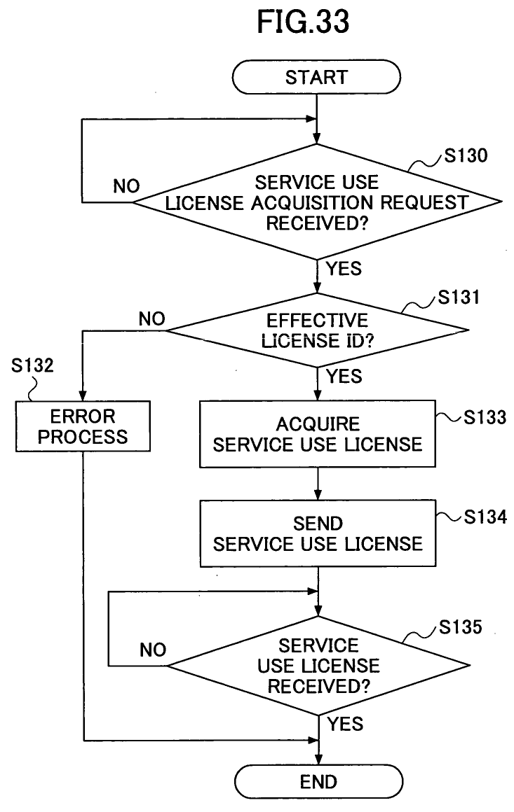

A description will be given below, with reference to FIG. 33, of another example of the license ID authentication process in the service management service 11. FIG. 33 is a flowchart of another example of the license ID authentication process in the service management service.

In step S130, the service use license management section 72 determines whether or not an acquisition request of a service use license 15 has been received from the service offer service 31. If it is determined by the service use license management section 72 that the acquisition request of the service use license 15 has been received (YES in step S130), the routine proceeds to step S131. On the other hand, if it is determined that the acquisition request of the service use license 15 has not been received (NO in step S130), the process of step S130 is repeated.

In step S131, the service use license management section 72 determines whether or not the license ID 25 contained in the acquisition request of the service use license 15 received from the service offer service 31 is effective. If it determined by the service use license management section 72 that the license ID 25 is effective (YES in step S131), the routine proceeds to step S133. On the other hand, if it is determined that the license ID 25 is not effective (NO in step S131), the routine proceeds to step S132.

In step S132, the service use license management section 72 sends to the session management section 81 information indicating that the acquired license ID 25 is not effective, and the process is ended. On the other hand, in step S133, the service use license management section 72 acquires the corresponding service use license 15 from the license ID management table 26 of FIG. 20 based on the acquired license ID 25.

Following step S133, the routine proceeds to step S134 where the service use license management section 72 sends the service use license 15 acquired in step S133 to the session management section 81.

Following step S134, the routine proceeds to step S135 where the service use license management section 72 determines whether or not the service use license 15, which was sent to the session management section 81 in step S134, has been returned from the session management section 81. If it is determined by the service use license management section 72 that the service use license has been returned from the session management section 81 (YES in step S135), the process is ended. On the other hand, if it is determined that the service use license 15 has not been returned (NO in step S135), the process of step S135 is repeated.

The process shown in FIG. 33 is the same as the process explained with reference to FIG. 28.

According to the first embodiment of the present invention explained with reference to FIG. 11 through FIG. 33, the session the session management section 71 of the service management service 11 increments the value indicating the status of use of the service use license 15 when acquiring the service use license 15 from the authentication section 73 after receiving from the service use service 21 the start request of the session with the service use service 21. Therefore, after that, even if the service use service 21 establishes sessions with a plurality of service offer services 31 and sends acquisition requests of services, and, thus, each of the service offer services 31 requests acquisition of the service use license 15 to the service management service 11 and the service management service 11 sends the service use license to each of the service offer services 31, the same service use license 15 is commonly used thereby preventing the value indicating the status of use of the service use license 15 from being incremented. Therefore, the service use license 15 can be prevented from being consumed unnecessarily.

### Second Embodiment

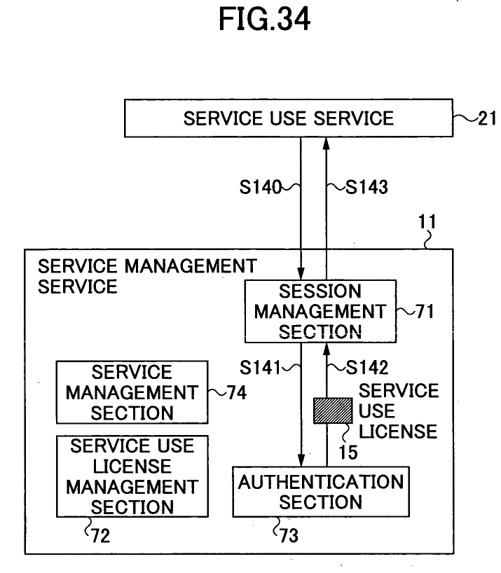

A description will be given below, with reference to FIG. 34 through FIG. 39, of a second embodiment of the present invention.

The second embodiment differs from the first embodiment in that a timing of incrementing the value indicating the status of use of the service use license is different.

A description will be given below of points different from the first embodiment, a description of points the same as the first embodiment will be omitted. FIG. 34 is an illustration for explaining another example of a start procedure of a session between the service use service and the service management service.

In step S140, the session management section 71 receives a first session start request sent from the service use service 21. The first session start request is the same as that explained with reference to FIG. 12.

Following step S140, the routine proceeds to step S141 where the session management section 71 sends to the authentication section 73 a service use license issue request, which includes a user ID, a password, etc., contained in the session start request received in step S140.

Following step S141, the routine proceeds to step S141 where the session management section 71 receives the service use license 15, which was issued by the authentication section. The session management section 71 produces the first session object 17 shown in FIG. 14, and adds the service use license 15 acquired in step S142 to the first session object 17. Moreover, the session management section 71 adds the first session object 17 to the first session management table 18 shown in FIG. 15.

Following step S142, the routine proceeds to step S143 where the session management section 71 produces a session start response such as shown in FIG. 13 containing the first session ID 16 which indicates a permission of use of the service management service 11.

In the second embodiment, unlike the first embodiment explained with reference to FIG. 11, the session management section 71 does not increment the value indicating the status of use of the service use license 15 when acquiring the service use license 15 from the authentication section 73.

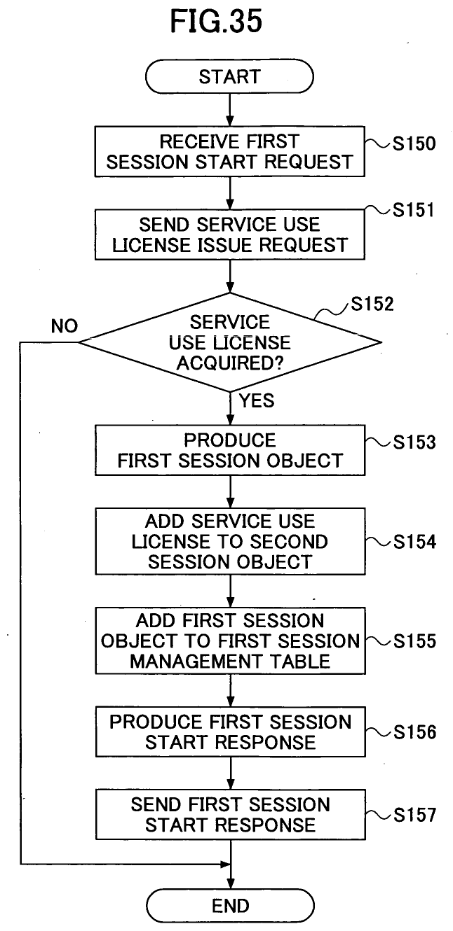

A description will now be given below, with reference to FIG. 35, of another example of a start process of a session between the service use service 21 and the service management service 11. FIG. 35 is a flowchart of another example of a start process of a session between the service use service and the service management service.

In step S150, the session management section 71 receives the first session start request such as shown in FIG. 12, which includes authentication information, from the service use service 21. Following step S150, the routine proceeds to step S151 where the session management section 71 sends an issue request of a service use license 15 to the authentication section 73 by using authentication information contained in the first session start request received in step S150.

Following step S151, the routine proceeds to step S152 where the session management section 71 determines whether or not the service use license 15 has been acquired from the authentication section 73. If it is determined that the service use license 15 has been acquired from the authentication section 73 (YES in step S152), the routine proceeds to step S153. On the other hand, if it is determined that the service use license 15 has not been acquired (NO in step S152), it is determined that the authentication information is not correct, and the process is ended.

In step S153, the session management section 71 produces the first session object 17 such as shown in FIG. 14. Following step S153, the routine proceeds to step S154 where the session management section 71 adds the service use license 15 acquired in step S152 to the first session object 17 produced in step S153.

Following step S154, the routine proceeds to step S155 where the session management section 71 adds the first session object 17, to which the service use license 15 is added in step S154, to the first session management table 18 shown in FIG. 15. Following step S155, the routine proceeds to step S 156 where the session management section 71 produces the first session start response containing the first session ID 16 as shown in FIG. 13. Following step S156, the routine proceeds to step S157 where the session management section 71 sends the first session start response produced in step S156 to the service use service 21.

In the second embodiment, unlike the first embodiment explained with reference to FIG. 16, even when the session management section 71 acquired the service use license 15 from the authentication section 73, the session management section 71 does not increment the value indicating the status of use of the service use license 15.

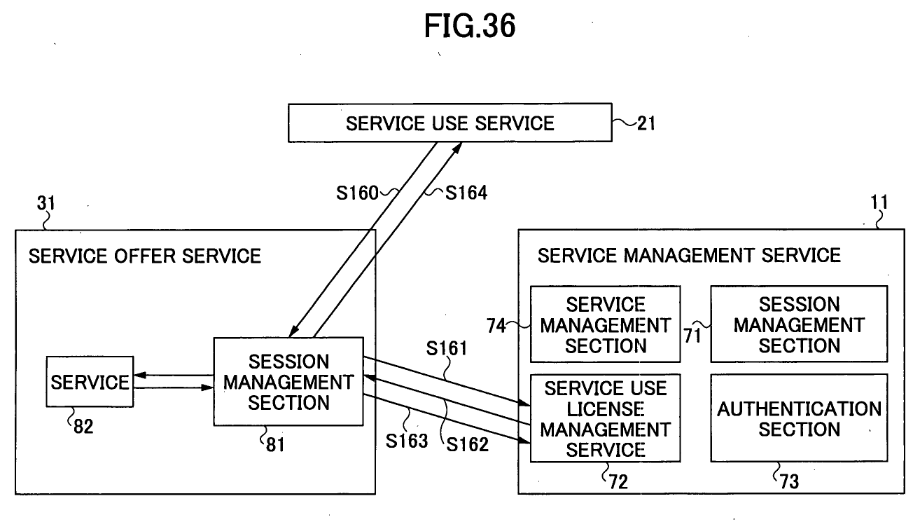

A description will be given below, with reference to FIG. 36, of another example of a start procedure of a session between the service use service 21 and the service offer service 31. FIG. 36 is an illustration for explaining another example of the start procedure of the session between the service use service and service offer service. It should be noted that since the license ID acquisition procedure is the same as that of the first embodiment, and a description thereof will be omitted.

In step S160, the service offer service 31 receives the second session start request such as shown in FIG. 23 sent from the service use service 21. Following step S160, the routine proceeds to step S161 where the session management section 81 sends to the service use license management part 72 an acquisition request of the service use license 15, which contains the license ID 25 contained in the second session start request acquired in step S160.

Following step S161, the routine proceeds to step S162 where the service use license management section 72 acquires the corresponding service use license 15 from the license ID management table 26 of FIG. 20 by using the license ID 25 contained in the acquisition request of the service use license 15 sent from the session management section 81, and sends the acquired service use license 15 to the session management section 81. The service use license management section 72 increments the value indicating the status of use of the service use license 15, when sending the service use license 15 to the session management section 81. The session management section 81 performs a predetermined process such as an initialization of services by using the received service use license 15, and produces the second session object 36 as shown in FIG. 25. The session management section 81 adds the license ID 25 to the produced second session object 36, and adds the second session object 36 to the second session management table 37 shown in FIG. 26.

Following step S162, the routine proceeds to step S163 where the session management section 81 sends the service use license 15 to the service use license management section 72. The service use license management section 72 decrements the value indicating the status of use of the service use license 15 when acquiring the service user license 15 sent from the session management section 81. Thus, the service use license 15 is provided only when a request is made, and, thereby the service use license 15 is prevented from being consumed while the session is established between the service use service 21 and the service offer service 31.

Following step S163, the routine proceeds to step S164 where the session management section 81 produces a second session start response as shown in FIG. 24 containing the second session ID 35, which indicates a permission of use of the service offer service 31, and sends the second session start response to the service use service 21.

In the second embodiment, unlike the first embodiment explained with reference to FIG. 22, the service use license management section 72 increments the value indicating the status of use of the service use license 15 by one each time the service use license 15 is sent upon a request from the session management section 81, and the service use license management section 72 decrements the value indicating the status of use of the service use license 15 when the service use license 15, which was sent, is returned.

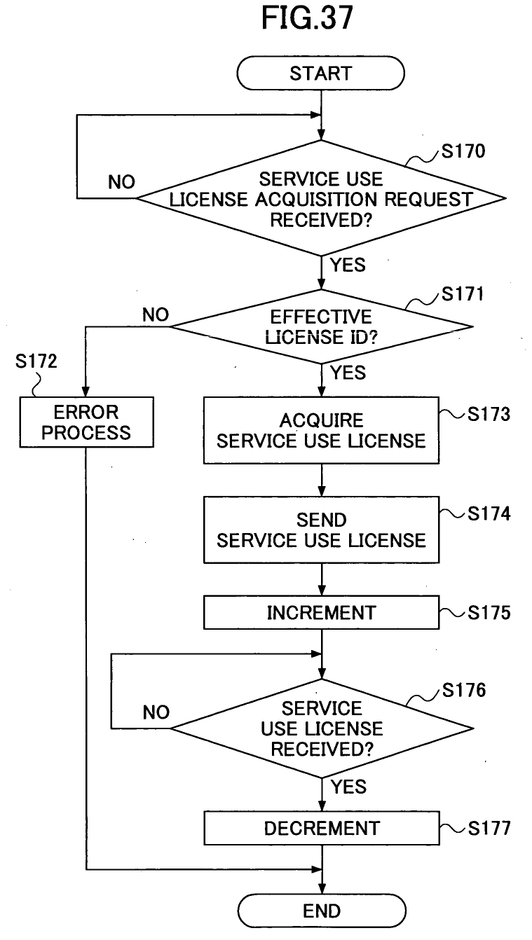

A description will be given below, with reference to FIG. 37, of another example of the license ID authentication process. FIG. 37 is a flowchart of another example of the license ID authentication process.

In step S170, the service use license management section 72 judges whether or not the acquisition request of the service use license 15 has been received from the service offer service 31. If it is determined by the service use license management section 72 that the acquisition request of the service use license 15 has been received (YES in step S170), the routine proceeds to step S171. On the other hand, if it is determined that the service use license 15 has not been received (NO in step S170), the process of step S170 is repeated.

In step S171, the service use license management section 72 determines whether or not the license ID 25 contained in the acquisition request of the service use license 15 received from the service offer service 31 is effective. If it is determined by the service use license management section 72 that the license ID 25 is effective (YES in step S171), the routine proceeds to step S173. On the other hand, if it is determined that the license ID 25 is not effective (NO in step S171), the routine proceeds to step S172.

In step S172, the service use license management section 72 sends information, which indicates that the acquired license ID 25 is not effective, to the session management section 81, and the process is ended. In step S173, the service use license management section 72 acquires the corresponding service use license 15 from the license ID management table 26 shown in FIG. 20 based on the license ID 25.

Following step S173, the routine proceeds to step S174 where the service use license management section 72 sends the service use license 15 acquired in step S173 to the session management section 81. Following step S174, the routine proceeds to step S175 where the service use license management section 72 increment by one the value indicating the status of use of the service use license 15.

Following step S175, the routine proceeds to step S176 where the service use license management section 72 determines whether or not the service use license 15, which was sent to the session management section 81 in step S174, has been returned from the session management section 81. If it is determined by the service use license management section 72 that the service use license 15 has been returned from the session management section 81 (YES in step S176), the routine proceeds to step S177. On the other hand, if it is determined that the service use license has not been returned (NO in step S176), the process of step S176 is repeated.

In step S177, the service use license management section 72 decrements by one the value indicating the status of use of the service use license 15.

In the second embodiment, unlike the first embodiment explained with reference to FIG. 28, the service use license management section 72 increments the value indicating the status of use of the service use license 15 each time the service use license 15 is sent upon a request made by the session management section 81, and the service use license management section 72 decrements the value indicating the status of use of the service use license 15 when the service use license 15, which was sent to the session management section 81, is returned.

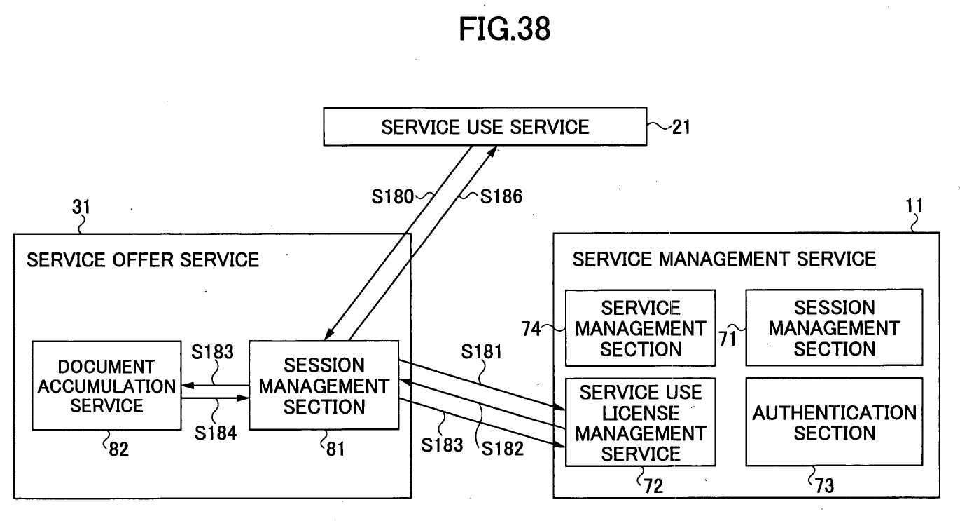

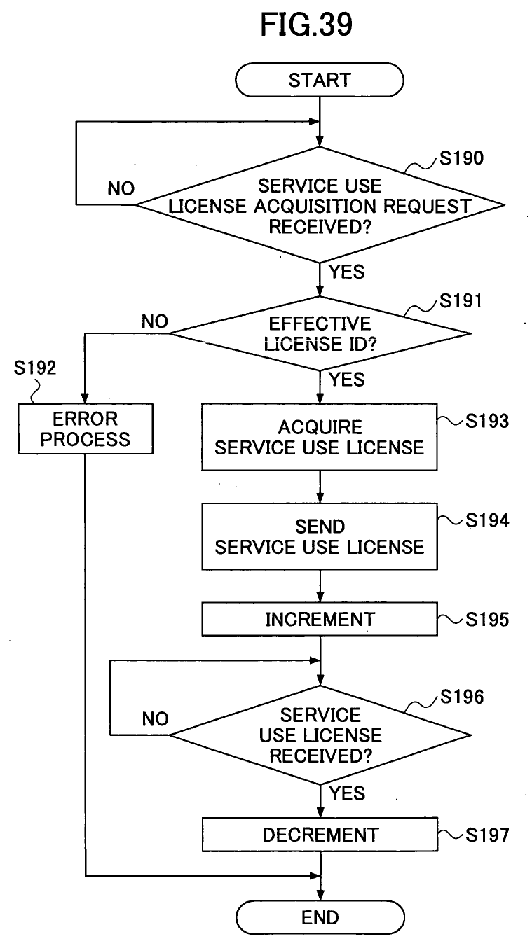

A description will be given below, with reference to FIGS. 38 and 39, of a process associated with service offer on the assumption that the service to offer is the document accumulation service 82 which accumulates documents. FIG. 38 is an illustration for explaining another example of the accumulated document acquisition procedure.

In step S180, the service offer service 31 receives an accumulated document acquisition request as shown in FIG. 30 sent from the service use service 21. The session management section 81 acquires the corresponding second session object 36 from the second session management table 27 shown in FIG. 26 based on the second session ID 35 contained in the accumulated document acquisition request. Moreover, the session management section 81 acquires the license ID 25 from the acquired second session object 36.

Following step S180, the routine proceeds to step S181 where the session management section 81 sends the acquisition request containing the acquired license ID 25 of the service use license 15 to the service use license management section 72. Following step S181, the routine proceeds to step S182 wherein the service use license management section 72 acquires the corresponding service use license 15 from the license ID management table 26 shown in FIG. 20 by using the license ID 25 contained in the acquisition request of the service use license 15 sent from the session management section 81, and sends the service use license 15 to the session management section 81. The service use license management section 72 increments by one the value indicating the status of use of the service use license 15 when sending the service use license 15 to the session management section 81.

Following step S182, the routine proceeds to step S183 where the session management section 81 sends to the document accumulation service 82 an acquisition request of the accumulated document designated by the accumulated document acquisition request received in step S180 by using the service use license 15 received in step S182. Following step S183, the routine proceeds to step S184 where the session management section 81 acquires the accumulated document requested in step S183 from the document accumulation service 82. Following step S185, the routine proceeds to step S185 where the session management section 81 sends the service use license 15 to the service use license management section 72. The service use license management section 72 decrements by one the value indicating the status of use of the service use license 15 when acquiring the service use license 15 sent from the session management section 81.

Following step S185, the routine proceeds to step S186 where the session management section 81 produces an accumulated document acquisition response such as shown in FIG. 31 containing the accumulated document acquired in step S184, and sends the accumulated document acquisition response to the service use service 21.

A description will be given below, with reference to FIG. 39, of another example of the license ID authentication process in the service management service 21. FIG. 39 is a flowchart of another example of the license ID authentication process in the service management service.

In step S190, the service use license management section 72 determined whether or not an acquisition request of the service use license 15 has been received from the service offer service 31. If it is determined by the service use license management section 72 that the acquisition request of the service use license 15 has been received (YES in step S190), the routine proceeds to step S191. On the other hand, if it is determines that the acquisition request of the service use license 15 has not been received (NO in step S190), the process of step S190 is repeated.

In step S191, the service use license management section 72 determines whether or not the license ID 25 contained in the acquisition request of the service use license 15 which was received from the service offer service 31 is effective. If it is determined by the service use license management section 72 that the license ID 25 is effective (YES in step S191), the routine proceeds to step S193. On the other hand, if it is determined that the license ID 25 is not effective (NO in step S191), the routine proceeds to step S192.

In step S192, the service use license management section 72 sends to the session management section 81 information indicating that the acquired license ID 25 is not effective, and the process is ended. In step S193, the service use license management section 72 acquires the corresponding service use license 15 from the license ID management table 26 of FIG. 20 based on the license ID 25.

Following step S193, the routine proceeds to step S194 where the service use license management section 72 sends the service use license 15 acquired in step S193 to the session management section 81. Following step S194, the routine proceeds to step S195 where the service use license management section 72 increments the value indicating the status of use of the service use license 15.

Following step S195, the routine proceeds to step S196 where the service use license management section 72 determines whether or not the service use license, which was sent to the session management section 81 in step S194, has been returned from the session management section 81. If it is determined by the service use license management section 72 that the service use license 15 has been returned from the session management section 81 (YES in step S196), the routine proceeds to step S197. On the other hand, if it is determined that the service use license 15 has not been returned (NO in step S196), the process of step S196 is repeated.

In step S197, the service use license management section 72 decrements the value indicating the status of use of the service use license 15.

The process in FIG. 39 is the same as the process explained with reference to FIG. 37.

According to the second embodiment of the present invention explained with reference to FIG. 34 through FIG. 39, the service management service 11 mrely increments the value indicating the status of use of the service use license 15 only for a time period during which the service use license 15 is provided to the service offer service 31 based on the request from the service offer service 31. Accordingly, the value of the status of use of the service use license 15 can be prevented from being incremented during a session between the service use service 21 and the service offer service 31. Therefore, the service use license 15 is prevented from being consumed unnecessarily.

It should be noted that, unlike the first embodiment, the second embodiment is constituted so that the service use license cannot be shared with a plurality of service offer services 31.

### Third Embodiment

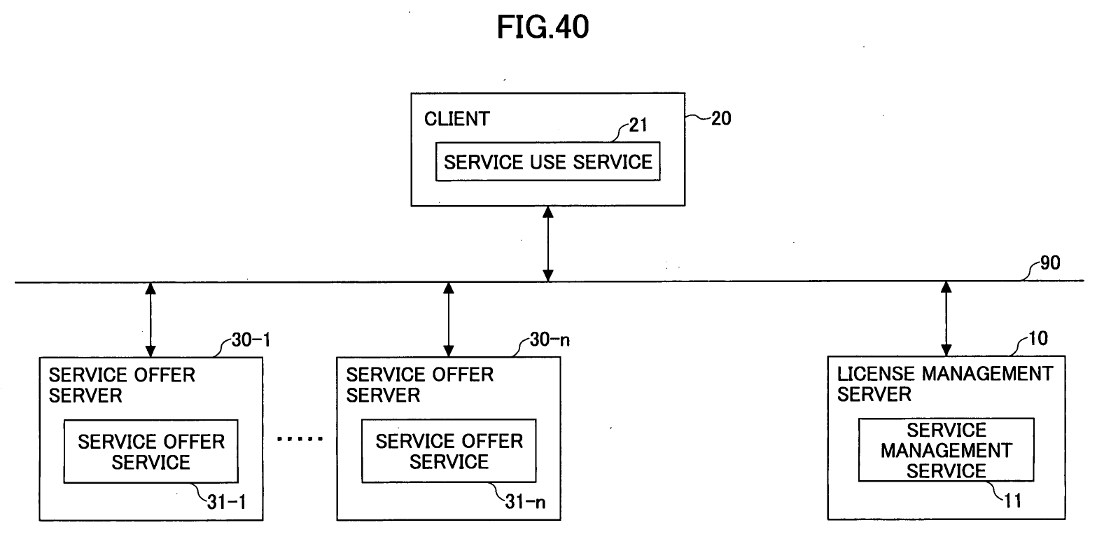

FIG. 40 is a block diagram for explaining another example in which the service management service and the service offer services operate in separate servers.

As shown in FIG. 40, the service offer services 31-1 to 31-n are configured and arranged to be contained in a plurality of service offer servers 30, respectively.

### Fourth Embodiment

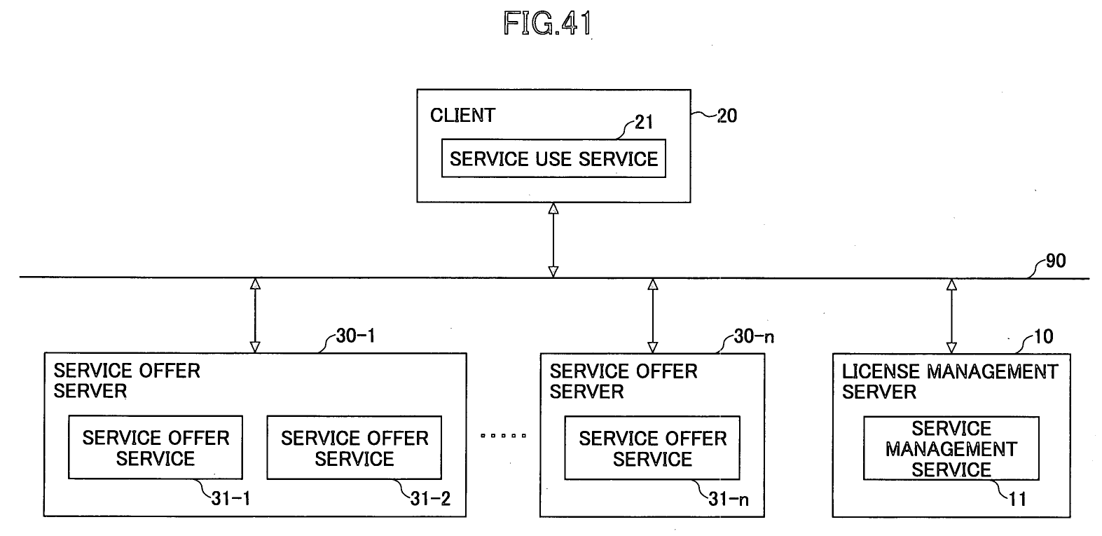

FIG. 41 is a block diagram for explaining another example in which the service management service and the service offer services operate in separate servers.

As shown in FIG. 41, a part of the service offer services 31-1 to 31-n (the service offer services 31-1 and 31-2 in the figure) are contained in the same service offer server 30-1, and other parts of the service offer services 31-1 to 31-n are contained in a plurality of service offer servers 30-2 to 30-n, respectively.

### Fifth Embodiment

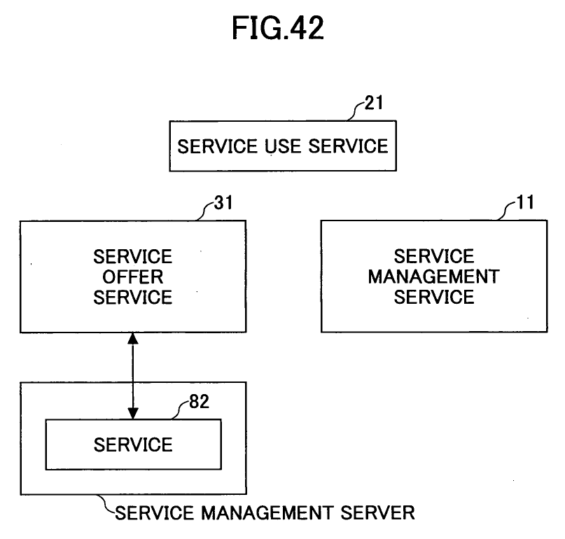

FIG. 42 is a block diagram for explaining an example in which the service operates outside the service offer service.

As shown in FIG> 42, the service 82 can exist and operable outside the service offer service 31. In the example shown in FIG. 42, the service 82 exists in a service management server.

### Sixth Embodiment

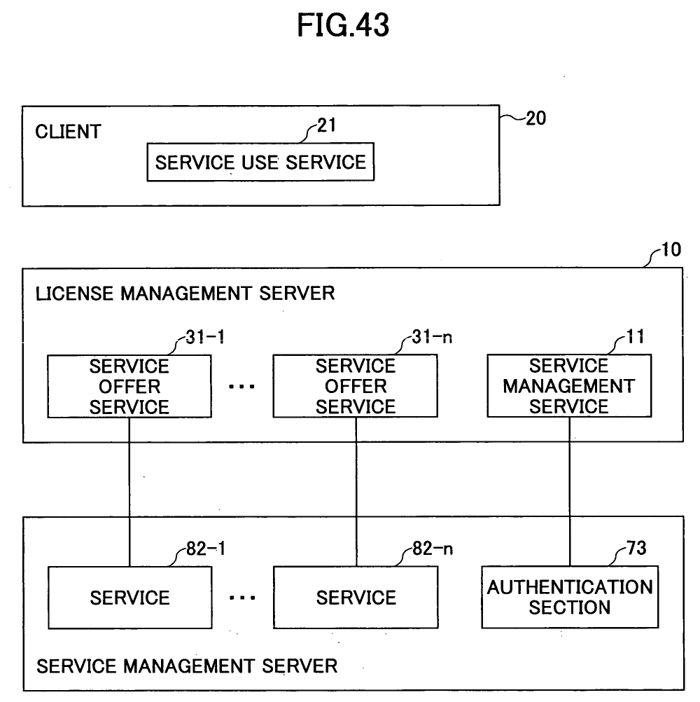

FIG. 43 is a block diagram for explaining an example in which the services and the service authentication section are in the same server.

As shown in FIG. 43, the services 82-1 to 82-n and the authentication section 73 operate in the same server such as a service management server.

### Seventh Embodiment

A description will be given of a seventh embodiment which is an example of a process of a case in which the license ID 25 and the service use license 15 explained in the first and second embodiments are the same as the first session ID 16 and session explained in the first and second embodiments. In the seventh embodiment, a session and a management of the session are shared by the service management service 11 and the service offer service 31.

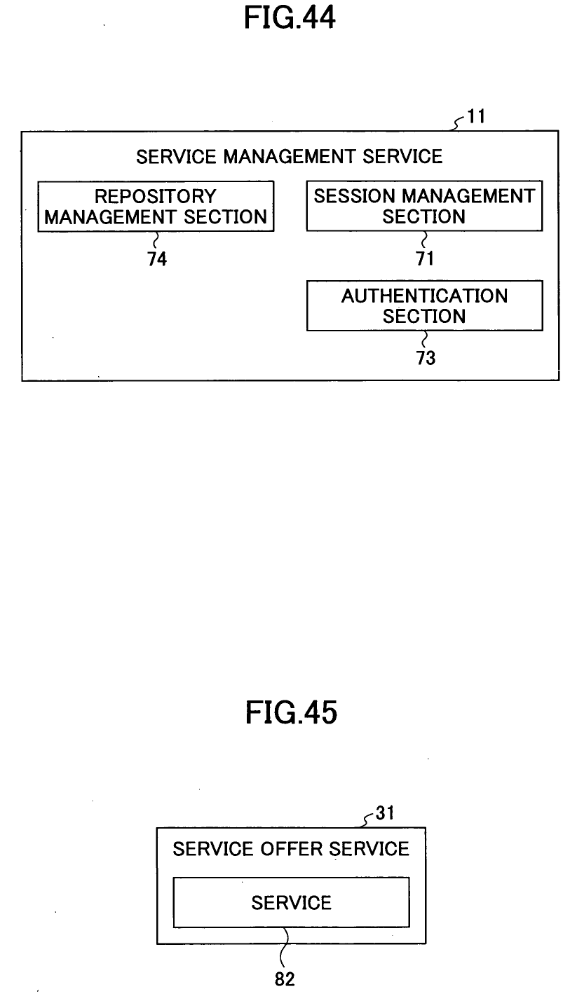

FIG. 44 is a functional block diagram of an example of a service management service in the seventh embodiment.

As shown in FIG. 44, a service management service 11 of the seventh embodiment comprises a session management section 71, an authentication section 73 and a service management section 74. The session management section 71, the authentication section 73 and the service management section 74 of the seventh embodiment are the same as the session management section 71, the authentication section 73 and the service management section 74 explained in the first and second embodiment.

However, the session managed in the session management section 71 of the seventh embodiment represents a session between the service management service 11 and the service use service 21, and corresponds to a permission of use of the service 82 similar to the service use license 15 explained in the first and second embodiments.

A description will be given below, with reference to FIG. 45, of an example of the service offer service 31 of the seventh embodiment. FIG. 45 is a functional block diagram of an example of the service offer service in the seventh embodiment.

As shown in FIG. 45, the service offer service 31 includes a service 82.

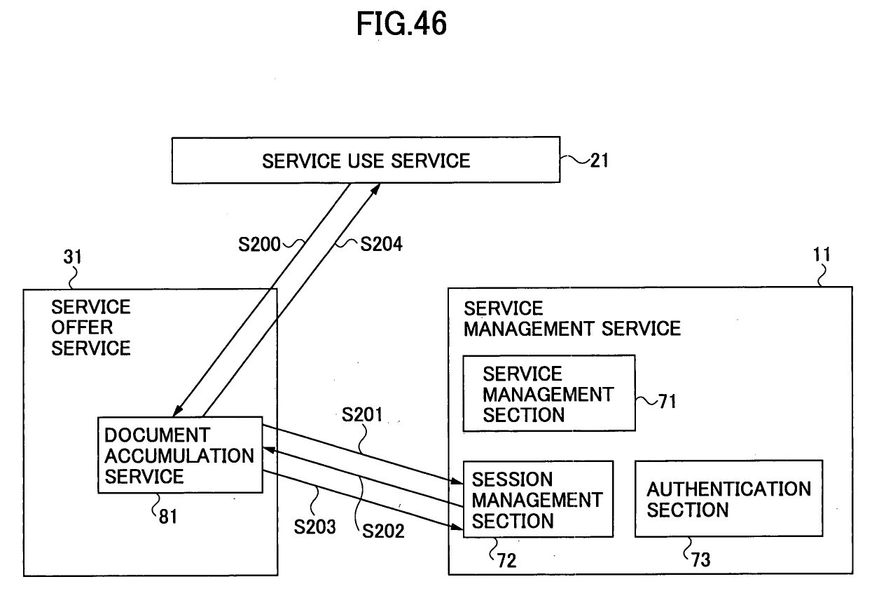

A description will be given below, with reference to FIG. 46, of an accumulated document acquisition procedure in the seventh embodiment on the assumption that the service 82 is a document accumulation service which accumulates documents. FIG. 46 is an illustration for explaining an example of the accumulated document acquisition procedure in the seventh embodiment.

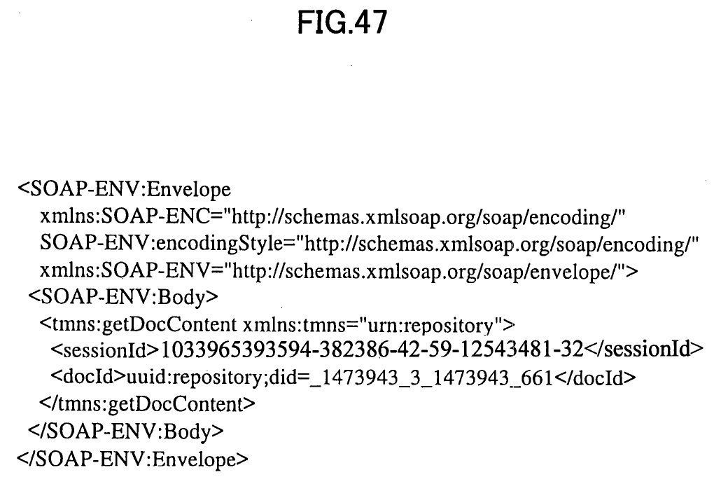

As shown in FIGS. 11 and 16 of the first embodiment, the service use service 21 acquires the first session ID 16 from the service management service 11. The service use service 21 sends an accumulated document acquisition request as shown in FIG. 47 and mentioned later to the service offer service 31 by using the first session ID 16.

In step S200, the service offer service 31 receives the accumulated document acquisition request shown in FIG. 47, which was sent from the service use service 21. Following step S200, the routine proceeds to step S201 where the service offer service 31 sends to the service management service 11 an acquisition request of a session corresponding to the first session ID 16 contained in the received accumulates document acquisition request.

Following step S201, the routine proceeds to step S202 where the service management service 11 authenticates the first session ID 16 contained in the acquisition request of the session sent from the service offer service 31. If it is determined that the first effective session ID 16 is effective, the service management service 11 acquires a session corresponding to the first session ID 16, and sends the above-mentioned result of determination and the session to service offer service 31. The service offer service 31, which acquired the session from the service management service 11, acquires the accumulated document designated in the accumulated document acquisition request received in step S200 from the document accumulation service 82 by using the session.

Following step S202, the routine proceeds to step S203 where the service offer service 31 sends the session to the service management service 11. Following step S203, the routine proceeds to step S204 where the service offer service 31 produces an accumulated document acquisition response as shown in FIG. 31 of the first embodiment containing the accumulated document, and sends the accumulated document acquisition response to the service use service 21.

A description will be given below, with reference to FIG. 47, of an example of the accumulated document acquisition request in the seventh embodiment. FIG. 47 is an illustration for explaining an example of the accumulated document acquisition request in the seventh embodiment.

As shown in FIG. 47, in the accumulated document acquisition request of the seventh embodiment, the first session ID 16 is provided between tags <sesionId> and </sesionId>.

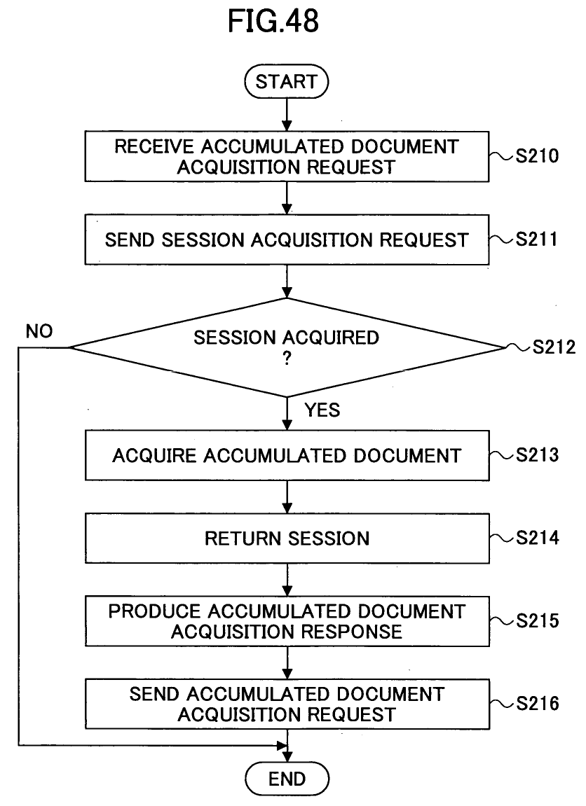

A description will be given below, with reference 48, of an example of the accumulated document acquisition process in the seventh embodiment. FIG. 48 is a flowchart of an example of the accumulated document acquisition process in the seventh embodiment.

In step S210, the service offer service 31 receives from the service use service 21 the accumulated document acquisition request as shown in FIG. 47 containing the first session ID 16. Following step S210, the routine proceeds to step S211 where the service offer service 31 sends to the service management service 11 an acquisition request of a session corresponding to the first session ID 16 contained in the received accumulated document acquisition request.

Following step S211, the routine proceeds to step following step S212 where the service offer service 31 determines whether or not the session has been acquired from the service management service 11. If it is determined by the service offer service 31 that the session has been acquired from the service management service 11 (YES in step S212), the routine proceeds to step S213. On the other hand, if it is determined that the session has not been acquired from the service management service 11 (NO in step S212), it is determined that the session ID is not correct, and the process is ended. In step S213, the service offer service 31 acquires from the document accumulation service 82 the accumulated document designated by the accumulated document acquisition request received in step S210 by using the session acquired in step S212.

Following step S213, the routine proceeds to step S214 where the service offer service 31 returns the session acquired in step S212 to the service management service 11. Following step S214, the routine proceeds to step 215 where the service offer service 31 produces an accumulated document acquisition response as shown in FIG. 31 of the first embodiment containing the accumulates document acquired in step S213. Following step S215, the routine proceeds to step S216 where the service offer service 31 sends the accumulated document acquisition response produced in step S213 to the service use service 21.

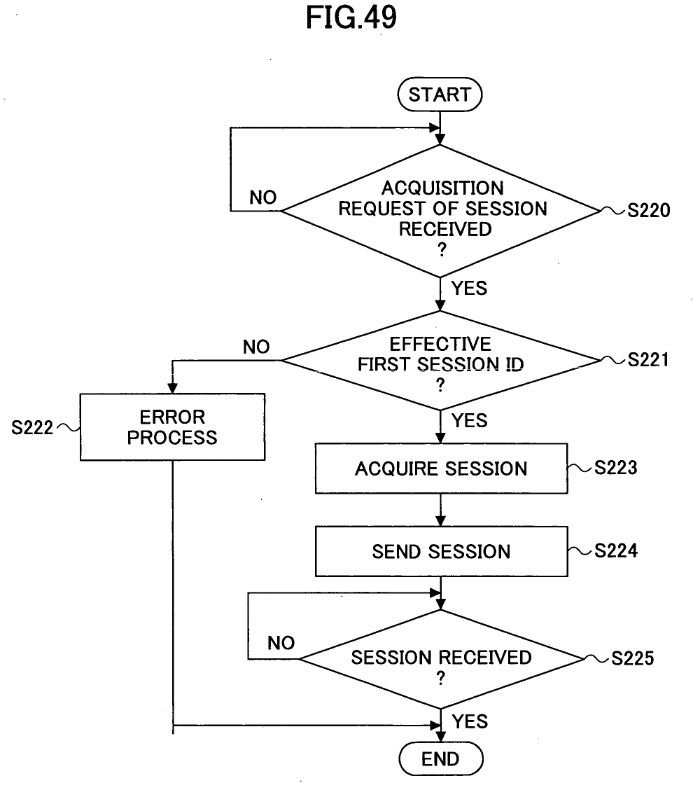

A description will be given below, with reference to FIG. 49, of an example of a first session ID authentication process in the seventh embodiment. FIG. 49 is a flowchart of an example of the first session ID authentication process in the seventh embodiment.

In step S220, the service management service 11 determines whether or not an acquisition request of a session has been received from the service offer service 31. If it is determined by the service management service 11 that the acquisition request of a session has been received from the service offer service 31 (YES in step S220), the routine proceeds to step S221. On the other hand if it is determined that the acquisition request of a session has not been received from the service offer service 31 (NO in step S220), the process of step S220 is repeated.

In step S221, the service management service 11 determines whether or not the first session ID 16 contained in the acquisition request of a session received in step S220 is effective. If it is determined by the service management service 11 that the first effective session ID 16 is effective (YES in step S221), the routine proceeds to step S223. On the other hand, if it is determined that the first effective session ID 16 is not effective (NO in step S221), the routine proceeds to step S22.

In step S222, the service management service 11 sends to the service offer service 31 information indicating that the first session ID 16 contained in the acquisition request of the session received in step S220 is not effective. In step S223, the service management service ii acquires from the session management section 71 the session corresponding to the first session ID 16 contained in the acquisition request of a session received in step S220.

Following step S223, the routine proceeds to step S224 where the service management service 11 sends the session acquired in step S223 to the service offer service 31 which made the request. Following step S224, the routine proceeds to step S225 where the service management service 11 determines whether or not the session sent to the service offer service 31 in step S224 has been returned from the service offer service 31. If it is determined by the service management service 11 that the session has been returned from the service offer service 31 (YES in step S225), the process is ended. On the other hand, if it is determined that the session has not been returned (NO in step S225), the process of step S225 is repeated.

It should be noted that, as explained in the first embodiment, in the seventh embodiment, the service use license 15 may be issued by the authentication section 73 and the value indicating the status of use of the service use license 15 may be incremented by one when the session management section 71 acquired the service use license.

Alternatively, as explained in the second embodiment, after the session is sent to the service offer service 31 based on the request made by the service offer service 31, the value indicating the status of use of the service use license 15, the value of the status of use of the service use license 15 may be incremented, and the value of the status of use of the service use license 15 may be decremented by one after the session is returned from the service offer service 31.

### Eighth Embodiment

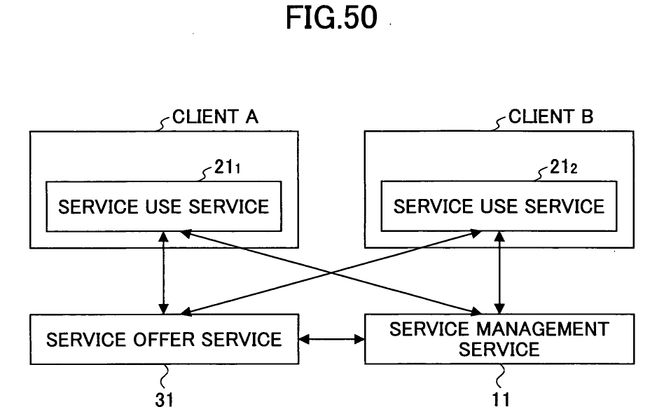

A description will be given below of an eighth embodiment as another example of the license management method and the service offer method using the license ID 25 explained in the first and second embodiments. FIG. 50 is an illustration for explaining an example of a system structure of the eighth embodiment according to the present invention.

As shown in FIG. 50, in the eighth embodiment, there are tow service use services 21.

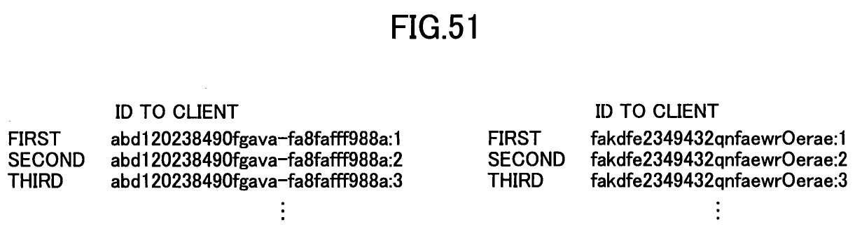

A description will be given below, with reference to FIG. 51, of an example in which the same license ID is converted into different character strings. FIG. 51 is an illustration for explaining an example in which the same license ID is converted into different character strings.

The service management service 11 converts the license ID explained with reference to FIG. 20 of the first embodiment into that shown in FIG. 51, and sends the converted license ID to the service use service 21 in response to a request.

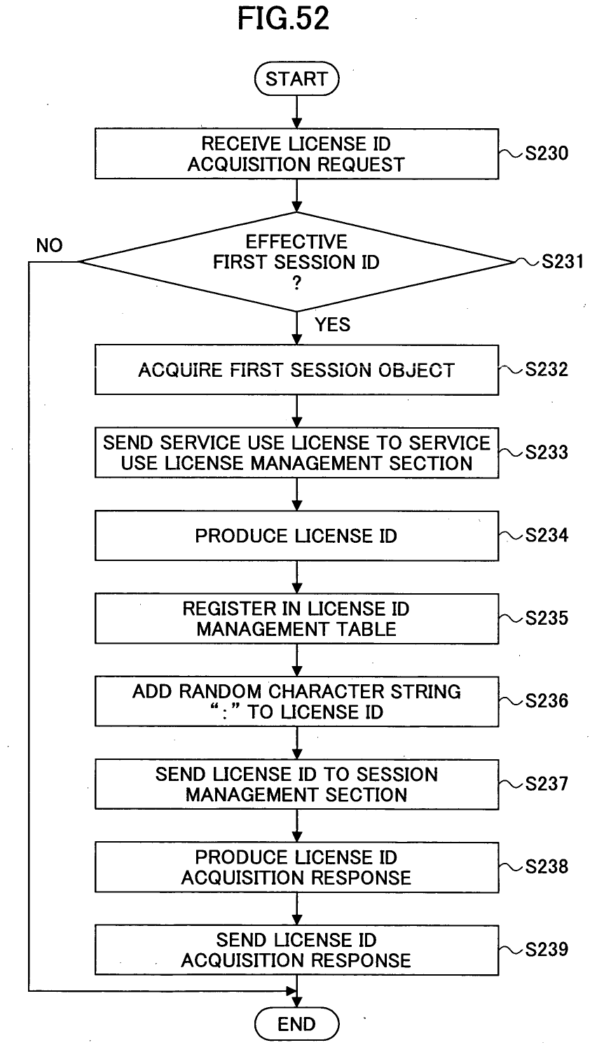

A description will be given below, with reference to FIG. 52, of an example of a license ID acquisition process in the eighth embodiment. It should be noted that a description will be given of a process in response to the first acquisition request of the license ID made by the same service use service 21. FIG. 52 is a flowchart of an example of the license ID acquisition process in the eighth embodiment.

In step S230, the session management section 71 receives from the service use service 21 a license ID acquisition request as shown in FIG. 18 of the first embodiment containing the first session ID 16. Following step S230, the routine proceeds to step S231 where the session management section 71 determines whether or not the first session ID 16 contained in the license ID acquisition request acquired in step S230 is effective. If it is determined by the session management section 71 that the first session ID 16 is effective (YES in step S231), the routine proceeds to step S232. On the other hand, if it is determined that the first session ID 16 is not effective (NO in step S231), the process is ended.

In step S232, the session management section 71 acquires the first session object 17 corresponding to the first session ID 16 contained in the license ID acquisition request from the first session management table 18 as shown in FIG. 15 of the first embodiment. Following step S232, the routine proceeds to step S233 where the session management section 71 acquires the service use license 15 from the first session object 17 acquired in step S232, and sends the acquired service use license 15 to the service use license management section 72.

Following step S233, the routine proceeds to step S233 where the service use license management section 72 produces the license ID 25, which discriminates the service use license 15 based on the service use license 15 acquired in step S233. Following step S234, the routine proceeds to step S235 where the service use license management section 72 registers the service use license 25 which received in step S233 and the license ID 25 produced in step S234 into the license ID management table 26 as shown in FIG. 20 of the first embodiment.

Following step S235, the routine proceeds to step S236 where the service use license management section 72 adds a colon “:” and a random character string to the license ID produced in step S234, as shown in FIG. 51. Following step S236, the routine proceeds to step S237 where the service use license management section 72 sends the license ID 25, to which-the colon and the character string are added in step S236, to the session management section 71. Following step S237, the routine proceeds to step S238 where the session management section 71 produces a license ID acquisition response containing the license ID 25 which is received in step S236 and includes the added colon and character string. Following step S237, the routine proceeds to step S238 where the session management section 71 sends the license ID acquisition response produced in step S237 to the service use service 21.

Thereafter, when the acquisition request of the license ID containing the same first session ID 16 is received from the same service use service 21, which has sent the license ID acquisition request of step S230, the service management service 11 adds a colon and a random character string to the same license ID, as shown in FIG. 51, by referring to the license ID management table 26, and sends the license ID to the service use service 21.

According to the above-mentioned structure, as explained in the second embodiment, when sending the service use license 15 to the service offer service 31, even if the value indicating the status of use of the service use license 15 is incremented by one, and also if the apparent license ID is different, an operation in which the value indicating the status of use of the service use license 15 is not incremented in a case where the same service use license 15 is sent.

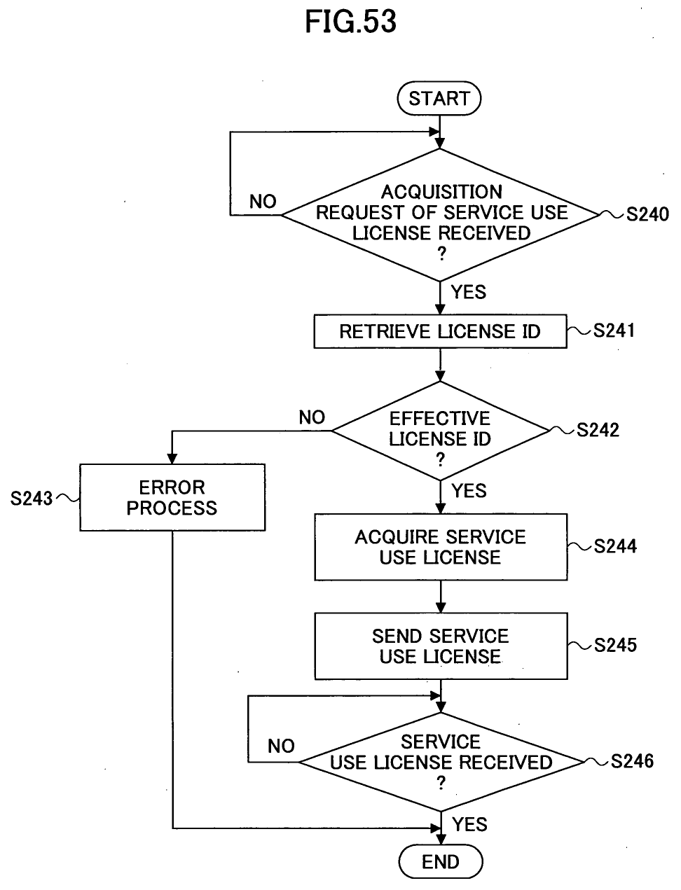

A description will be given, with reference to FIG. 53, of an example of the license ID authentication process in the eighth embodiment. It should be noted that, for the sake of simplification, it is assumed in FIG. 53 that the authentication section 73 produces the service use license and the value indicating the status of use of the service use license 15 is incremented when the session management section 71 acquires the service use license 15. FIG. 53 is a flowchart of an example of the license ID authentication process in the eighth embodiment.

In step S240, the service use license management section 72 determines whether or not an acquisition request of the service use license 15 has been received from the service offer service 31. If it is determined by the service use license management section 72 that the acquisition request of the service use license 15 has been received (YES in step S240), the routine proceeds to step S241. On the other hand, if it is determined that the acquisition request of the service use license 15 has not been received (NO in step S240), the process of step S240 is repeated.

In step S241, the service use license management section 72 retrieves the license ID, from which the colon and random character strings are removed, from the license ID which includes the colon and random character string and contained in the acquisition request of the service use license 15 received from the service offer service 31. Following step S241, the routine proceeds to step S242 where the service use license management section 72 determines whether or not the license ID 25 retrieved in step S241 is effective. If it is determined by the service use license management section 72 that the license ID 25 is effective (YES in step S242), the routine proceeds to step S244. On the other hand, if it is determined that the license ID 25 is not effective (NO in step S242), the routine proceeds to step S243.

In step S243, the service use license management section 72 to the session management section 81 information indicating that the acquired license ID 25 is not effective, and the process is ended. In step S244, the service use license management section 72 acquires the corresponding service use license 15 from the license ID management table 26 shown in FIG. 20 of the first embodiment based on the license ID 25.

Following step S244, the routine proceeds to step S245 where the service use license management section 72 sends the service use license 15 acquired in step S244 to the session management section 81. Following step S245, the routine proceeds to step S246 where the service use license management section 72 determined whether or not the service use license 15, which was sent to the session management section 81 in step S245, has been returned from the session management section 81. If it is determined by the service use license management section 72 that the service use license 15 has been returned (YES in step S246), the process is ended. On the other hand, if it is determined that the service use license 15 has not been returned (NO in step S246), the process of step S246 is repeated.

The present invention is not limited to the specifically disclosed embodiments, and variations and modifications may be made without departing from the scope of the present invention.

The present application is base on Japanese priority applications No. 2002-331210 filed Nov. 14, 2002, No. 2002-331211 filed Nov. 14, 2002, No. 2003-375267 filed Nov. 5, 2003 and No. 2003-375268 filed Nov. 5, 2003, the entire contents of which are hereby incorporated by reference.

What is claimed is:

1. A license management apparatus for managing a license associated with a service that is provided from service offer means to service use means, the license management apparatus comprising:
license management means for managing the license;
license acquisition request receiving means for receiving an acquisition request for the license from said service offer means; and
license sending means for sending the license to said service offer means in response to the acquisition request for the license.

2. The license management apparatus as claimed in claim 1, further comprising license counting means for counting a value associated with the license.

3. The license management apparatus as claimed in claim 2, wherein said license counting means counts the value when the license is acquired from authentication means that issues the license.

4. The license management apparatus as claimed in claim 2, wherein said license counting means counts the value when the license is sent to said service offer means in response to the acquisition request for the license.

5. The license management apparatus as claimed in claim 1, wherein the acquisition request for the license includes a license identifier that identifies the license.

6. The license management apparatus as claimed in claim 1, wherein said license management means manages the license and the license identifier that identifies the license by relating to each other.

7. The license management apparatus as claimed in claim 1, further comprising license identifier acquisition request receiving means for receiving an acquisition request for the license identifier that identifies the license.

8. The license management apparatus as claimed in claim 1, further comprising license identifier sending means for sending the license identifier to a requesting means in response to the acquisition request for the license identifier that identifies the license.

9. A service offer apparatus comprising service offer means for providing a service to service use means, wherein said service offer means comprises:
license acquisition request sending means for sending an acquisition request for the license associated with the service to license managing means for managing the license; and
license receiving means for receiving the license from said license management means.

10. The service offer apparatus as claimed in claim 9, wherein the acquisition request for the license contains a license identifier that identifies the license.

11. The service offer apparatus as claimed in claim 9, further comprising license sending means for sending the license acquired from said license management means to said license management means.

12. A license management method for managing a license associated with a service that is provided from service offer means to service use means, the license management method comprising:
a license management step of managing the license;
a license acquisition request receiving step of receiving an acquisition request for the license from said service offer means; and
a license sending step of sending the license to said service offer means in response to the acquisition request for the license.

13. The license management method as claimed in claim 12, further comprising a license counting step of counting a value associated with the license.

14. The license management method as claimed in claim 13, wherein, in said license counting step, the value associated with the license is counted when the license is acquired from authentication means that issues the license.

15. The license management method as claimed in claim 13, wherein, in said license counting step, the value associated with the license is counted when the license is sent to said service offer means in response to the acquisition request for the license.

16. The license management method as claimed in claim 12, wherein the acquisition request for the license includes a license identifier that identifies the license.

17. The license management method as claimed in claim 12, wherein, in said license management step, the license and the license identifier that identifies the license are managed by being related to each other.

18. The license management method as claimed in claim 12, further comprising a license identifier acquisition request receiving step of receiving an acquisition request for the license identifier that identifies the license.

19. The license management method as claimed in claim 12, further comprising a license identifier sending step of sending the license identifier to a requesting means in response to the acquisition request for the license identifier that identifies the license.

20. A service offer method for providing a service from service offer means to service use means, comprising:
a license acquisition request sending step of sending an acquisition request for the license associated with the service to license managing means that manages the license; and
a license receiving step of receiving the license from said license management means.

21. The service offer method as claimed in claim 20, wherein the acquisition request for the license contains a license identifier that identifies the license.

22. The service offer method as claimed in claim 20, further comprising a license sending step of sending the license acquired from said license management means to said license management means.

23. A license management program for causing a computer to perform a license management method for managing a license associated with a service that is provided from service offer means to service use means, the license management method comprising:
a license management step of managing the license;
a license acquisition request receiving step of receiving an acquisition request for the license from said service offer means; and
a license sending step of sending the license to said service offer means in response to the acquisition request for the license.

24. The license management program as claimed in claim 23, wherein the license management method further comprises a license counting step of counting a value associated with the license.

25. The license management program as claimed in claim 24, wherein, in said license counting step, the value associated with the license is counted when the license is acquired from authentication means that issues the license.

26. The license management program as claimed in claim 23, wherein, in said license counting step, the value associated with the license is counted when the license is sent to said service offer means in response to the acquisition request for the license.

27. The license management program as claimed in claim 12, wherein the acquisition request for the license includes a license identifier that identifies the license.

28. The license management program as claimed in claim 23, wherein, in said license management step, the license and the license identifier that identifies the license are managed by being related to each other.

29. The license management program as claimed in claim 23, wherein the license management method further comprises a license identifier acquisition request receiving step of receiving an acquisition request for the license identifier that identifies the license.

30. The license management program as claimed in claim 23, wherein the license management program further comprises a license identifier sending step of sending the license identifier to a requesting means in response to the acquisition request for the license identifier that identifies the license.

31. A service offer program for causing a computer to perform a service offer method for providing a service from service offer means to service use means, comprising:
a license acquisition request sending step of sending an acquisition request for the license associated with the service to license managing means that manages the license; and
a license receiving step of receiving the license from said license management means.

32. The service offer program as claimed in claim 31, wherein the acquisition request for the license contains a license identifier that identifies the license..

33. The service offer program as claimed in claim 31, wherein the service offer method further comprises a license sending step of sending the license acquired from said license management means to said license management means.

34. A computer-readable recording medium storing a license management program for causing a computer to perform a license management method for managing a license associated with a service that is provided from service offer means to service use means, the license management method comprising:
a license management step of managing the license;
a license acquisition request receiving step of receiving an acquisition request for the license from said service offer means; and
a license sending step of sending the license to said service offer means in response to the acquisition request for the license.

35. The computer-readable recording medium as claimed in claim 34, wherein the license management method further comprises a license counting step of counting a value associated with the license.

36. The computer-readable recording medium as claimed in claim 35, wherein, in said license counting step, the value associated with the license is counted when the license is acquired from authentication means that issues the license.

37. The computer-readable recording medium as claimed in claim 34, wherein, in said license counting step, the value associated with the license is counted when the license is sent to said service offer means in response to the acquisition request for the license.

38. The computer-readable recording medium as claimed in claim 34, wherein the acquisition request for the license includes a license identifier that identifies the license.

39. The computer-readable recording medium as claimed in claim 34, wherein, in said license management step, the license and the license identifier that identifies the license are managed by being related to each other.

40. The computer-readable recording medium as claimed in claim 34, wherein the license management method further comprises a license identifier acquisition request receiving step of receiving an acquisition request for the license identifier that identifies the license.

41. The computer-readable recording medium as claimed in claim 34, wherein the license management program further comprises a license identifier sending step of sending the license identifier to a requesting means in response to the acquisition request for the license identifier that identifies the license.

42. A computer-readable recording medium storing a service offer program for causing a computer to perform a service offer method for providing a service from service offer means to service use means, comprising:
a license acquisition request sending step of sending an acquisition request for the license associated with the service to license managing means that manages the license; and
a license receiving step of receiving the license from said license management means.

43. The computer-readable recording medium as claimed in claim 42, wherein the acquisition request for the license contains a license identifier that identifies the license.

44. The computer-readable recording medium as claimed in claim 42, wherein the service offer method further comprises a license sending step of sending the license acquired from said license management means to said license management means.
